(19) United States
(12) Patent Application Publication
(10) Pub. No.: US 2020/0298524 A1
(43) Pub. Date: Sep. 24, 2020

(54) DEVICE AND METHOD FOR PRODUCING PACKAGING TRAYS WITH DIFFERENT STRUCTURES AND PRODUCT OBTAINED

(71) Applicant: Juan Antonio HERRERO PEREZ RIO, San Andres Cholula, Puebla (MX)

(72) Inventors: Hugo TORRES GRANADOS, Puebla (MX); Efren Antonio DE URQUIJO CARMONA, Puebla (MX)

(73) Assignee: Juan Antonio HERRERO PEREZ RIOJA, San Andres Cholula, Puebla (MX)

(21) Appl. No.: 16/614,696

(22) PCT Filed: May 17, 2018
(86) PCT No.: PCT/IB2018/053485

§ 371 Date: May 26, 2020

(30) Foreign Application Priority Data
May 18, 2017 (MX) MX/A/2017/006573

(51) Int. Cl. B31B 50/28; B65D 5/20; B65D 5/4805; B65D 25/36

(52) U.S. Cl. CPC B31B 50/28; B65D 25/36; B65D 5/48022; B65D 5/20

(57) ABSTRACT

A method and apparatus for producing trays that are or are not coated with a plastic film and that retain modified atmospheres and the trays obtained. The apparatus allows for obtaining trays with different structures, which include the forming of the trays from previously elaborated preforms, which may or may not have a separator inside the trays and optionally coated with a plastic film inside. It also consists of the method for obtaining the trays and the trays obtained. The trays coated with a plastic film have the capacity to contain atmospheres with a composition of gases different from that of the air inside them, to extend the time of storage and conservation of food products. This is achieved by means of a closed “top seal” of the tray. The trays also have a simple closure or capping, without modifying their atmosphere.

### FIELD OF INVENTION

The present invention relates to the field of packaging of various products mainly food, particularly refers to a method and apparatus by which trays are produced, that can be or not coated with a plastic film and which retain modified atmospheres; it also refers to the trays obtained.

### ANTECEDENTS OF THE INVENTION

In the state of techniques there is a diversity of packaging for foods, as well as the device and methods that produce them, in the following, we will refer to some patents and patent applications that protect this type of invention.

Patent application: PA/a/1997/001595; A food package is described that comprise a food package tray and a food package wrapper that partially surrounds the tray. The food package wrapper has a lower ear positioned adjacent to at least a portion of the base and at least one side ear that extends from the lower ear and is positioned adjacent to at least a portion of the side wall.

The side ear has a section that is adhesively secured to the side wall. In this form, the food package wrap and the food package tray form a food package in which the surface area for printing food package directions is increased.

Patent application: PA/a/2008/013750: This invention generally refers to food packaging and methods of manufacture, and in particular to trays for containing food products and surrounded by an outer wrapping that surrounds them. The packaging being disclosed is to contain a plurality of individual food items within a tray that has a surrounding outer wrapper. The tray is configured to have increased rigidity in a longitudinal direction to increase packing speeds. In particular, the tray can be configured to accommodate higher pressure applications when deck seals are formed from the adjacent ends of the outer wrapper of the tray. The increased application of pressure has the benefit of being able to excel in a cover seal that requires less sealing time, allowing for increased packing speeds for forming, filling and sealing of the gaskets. Another benefit of the increased rigidity of the tray can be increased durability during shipping and handling.

Patent MX 313114: The present invention claim for a food package, for example a food tray which has a base and side walls of a dimensionally stable molded fiber layer to provide rigidity to the package and which encloses at least an internal volume and a layer of polymeric film laminated over the molded fiber layer, characterized by the fact that the food packaging comprises destacking notches within the circumference and adjacent to a circumferential edge, these notches include a stop surface that extends to the inside of the package to prevent the outside of the food package from touching the inside of another food package.

Patent: U.S. Pat. No. 4,265,390: The present invention refers to paperboard trays and more particularly to a paperboard tray that has features that make it particularly suitable for use when a coating film is formed or inserted into the tray in an automated manufacturing process.

To overcome the potential problems of interference, potential imperfections in the peripheral seals and differentially bent eyebrows, a tray has been invented that is particularly suitable for receiving a formed or inserted liner comprising a back wall panel and a plurality of side wall panels that generally extend vertically in relation to the back wall panel. A series of eyebrow panels are connected to the side panels.

Eyebrow panels are formed so that their ends are supported, but do not overlap when the eyebrows are in the desired end positions.

The bend line between each eyebrow panel and the associated side wall panel is selectively cut to compensate for different rigidity or resistance to bending forces.

Patent: U.S. Pat. No. 5,009,939: A gas-tight container suitable for food packaging is produced as a composite of cardboard and polymer film. A pair of pre-folded, pre-cut and pre-formed cardboard preforms are inserted into the opposite halves of divided mold elements of a blow molding machine.

Vacuum holes in each half of the mold temporarily secure the position of a respective cardboard shape. The cardboard-coated mold halves are closed over the hot, extruded, malleable polymer hollow tube, leaving one end of the malleable polymer hollow tube protruding from the closed mold unit. A fluid-conducting needle penetrates this protruding end portion to inflate the plastic tube with a suitable blowing gas.

Such inflation expands the malleable polymer, seamlessly, and incessantly, into the inner corners and cracks of folded cardboard forms. After cooling, the molding unit is opened and the pair of cardboard shapes are ejected as a single unit, joined by a molded eyebrow portion of the continuous polymer film.

Finally, the polymer-coated cardboard containers are separated by trimming around the eyebrows.

The documents referred to above, which belong to the State of the Art, describe inventions that are very different from the present invention.

For example the present invention does not have a food package wrapper which has a lower ear placed adjacent to at least a portion of the base and at least one side ear extending from the lower ear and is placed adjacent to at least a portion of the side wall; particularly it has no ear.

The present invention does not comprise a tray which is configured to have increased rigidity in a longitudinal direction to increase the packing speeds. In particular, the tray can be configured to accommodate higher pressure applications when deck seals are formed from the adjacent ends of the outer wrapping of the tray. The present invention does not consist of a food package comprising de-stacking notches within the circumference and adjacent to a circumferential edge, these notches comprising a stop surface extending to the inside of the package, to prevent the outside of the food package from touching the inside of another food package.

The present invention does not have the features that a series of eyebrow panels are connected to the side panels, the eyebrow panels are formed so that their end parts are supported, but do not overlap when the eyebrows are in the desired end positions

The bend line between each eyebrow panel and the associated side wall panel is selectively cut to compensate for different rigidity or resistance to bending forces. The coated trays of the present invention are not obtained by a process consisting of the mold halves coated with a material, which are closed over a hollow, hot, extruded malleable polymer tube, leaving a final part of the hollow malleable polymer tube protruding from the closed mold unit; a fluid-conducting needle penetrates this protruding end to inflate the plastic tube with a suitable blowing gas; such inflation expands the malleable polymer smoothly and incessantly into the inner corners and cracks of the bent material forms. That is, the method used to coat trays with a plastic film is that known as blow molding, which is very different from the method of the present invention.

The differences referred to above will become more evident when describing the present invention.

Is therefore an object of the present invention to provide an apparatus for the manufacture of various types of trays for the packaging of various products, mainly foodstuffs.

Another object of the present invention is that different types of trays are manufactured in the same apparatus for the packaging of various products, mainly foodstuffs.

Another object of the invention is to provide an apparatus for the manufacture of trays for packaging of various products, mainly foodstuffs, which may contain modified atmospheres.

Another object of the present invention is to provide a method of operating the apparatus for the manufacture of food packaging trays.

Still another object of the invention is to provide trays containing one or more compartments which are coated with plastic film or not.

### FIGURE DESCRIPTION

FIG. 1 corresponds to a view of the apparatus of the present invention for the manufacture of trays for packaging products, particularly foodstuffs.

FIG. 2 shows the first station of the apparatus of the present invention, for supplying the preforms of a separator forming part of the trays.

FIG. 3 shows the second station of the apparatus of the present invention, where the separator forming part of the trays is formed.

FIG. 4 shows the third station of the apparatus of the present invention, where adhesive is injected into certain parts of the shape of the tray separator.

FIG. 5 shows the fourth station of the apparatus of the present invention, where the preforms of the trays are supplied.

FIG. 6 shows the fifth station of the apparatus of the present invention, where adhesive is applied to certain parts of the preform of the tray.

FIG. 7 shows the sixth station of the apparatus of the present invention, in which the pre-bending of the tray flaps is done.

FIG. 8 refers to the part of the apparatus where the trays are molded and coated with a plastic film.

FIG. 9 shows the seventh station, where differentiated pressure is provided in parts of the tray.

FIG. 10 corresponds to a part of the plastic film cutting device, which is part of the seventh station.

FIG. 11 refers to another part of the plastic film cutting device, which is part of the seventh station.

FIG. 12 shows the part of the machine where the trays are unmold.

FIG. 13 is a plan view of a preform of a tray with separator.

FIG. 14 shows a plan view of the separator preform that is part of the trays.

FIG. 15 shows in an isometric view a tray with a separator that has walls forming a vertex.

FIG. 16 is a side view of a tray with a separator on the smaller side.

FIG. 17 is a side view of a tray cut with a separator on the larger side.

FIG. 18 shows a plan view of a tray with a separator in its middle, with or without plastic

FIG. 19 refers to an isometric view of the separator with walls forming a vertex.

FIG. 20 shows a plan view of a preform of a tray without separator formed with or without plastic film.

FIG. 21 shows an isometric view of a formed tray without a separator.

FIG. 22 refers to a front side view of the formed tray without a separator

FIG. 23 is a side view of the longest side of the formed tray without a separator.

FIG. 24 shows a plan view of a formed tray, without separator with or without plastic film.

FIG. 25 is a plan view of a preformed tray with separator.

FIG. 26 refers to a preform view of a separator.

FIG. 27 is an isometric view of a tray with a separator, which has a flat surface at the top.

FIG. 28 shows a plan view below the tray with separator as in FIG. 27.

FIG. 29 refers to a plan view of the tray with separator as in FIG. 27.

FIG. 30 refers to a front side view of the formed tray with separator as in FIG. 27.

FIG. 31 refers to a side view of the tray formed with separator as in FIG. 27.

FIG. 32 shows an isometric view of the separator with a flat surface on top.

FIG. 33 shows a plan view of a tray lid with a built-in clip.

FIG. 34 corresponds to a cutaway view of the shorter side of the lid for the tray in FIG. 21.

The above figures correspond from 1 to 12, to the seven stations of the apparatus of the present invention.

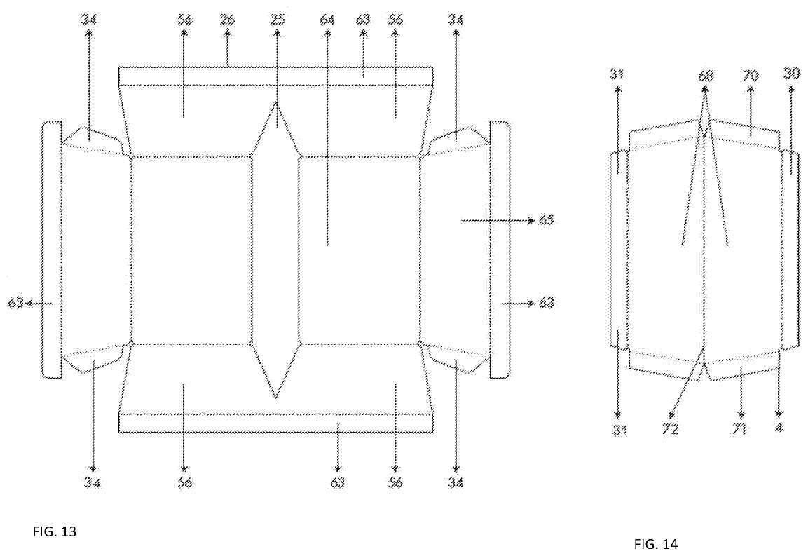

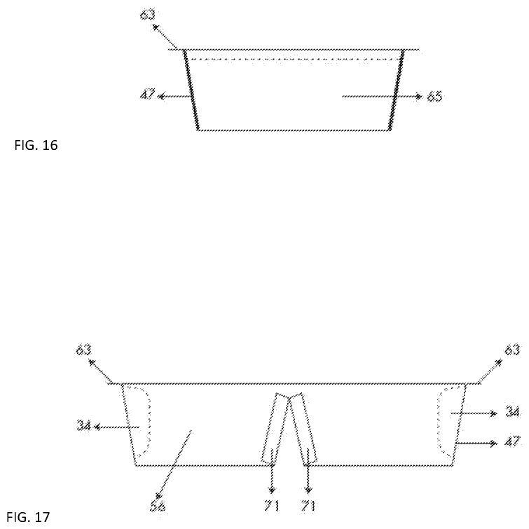

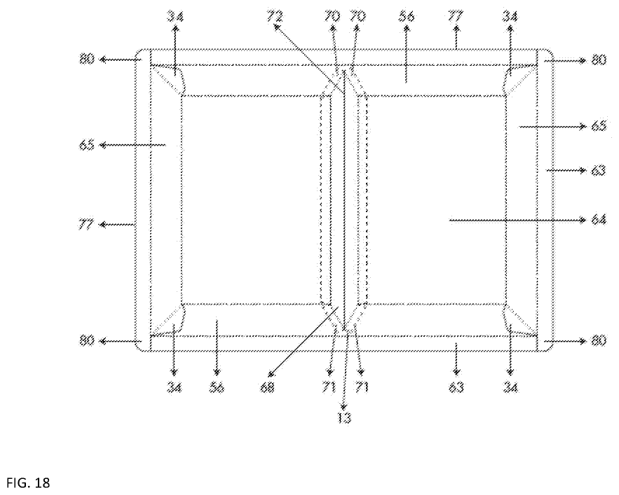

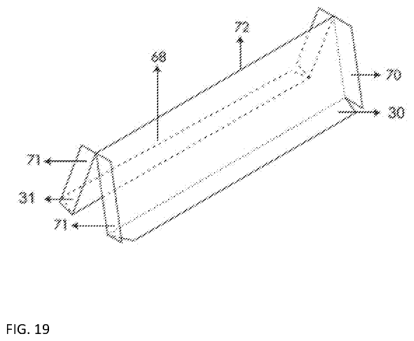

From FIGS. 13 to 19 to the trays with a separator that forms a vertex at the top of the walls of the tray.

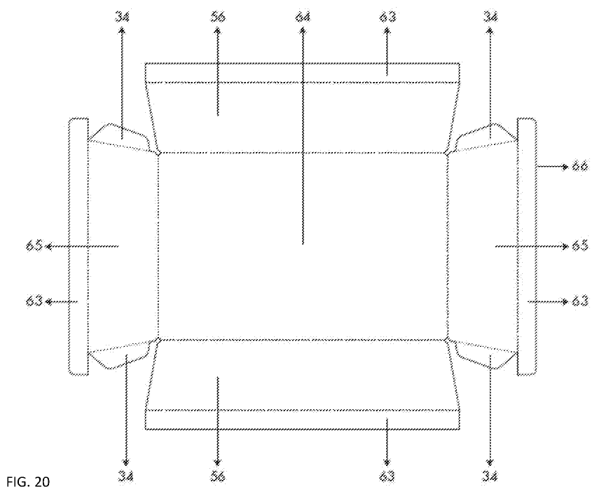

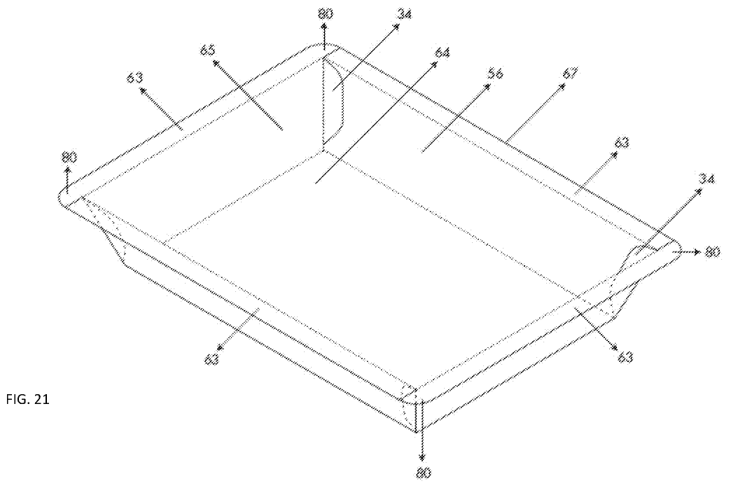

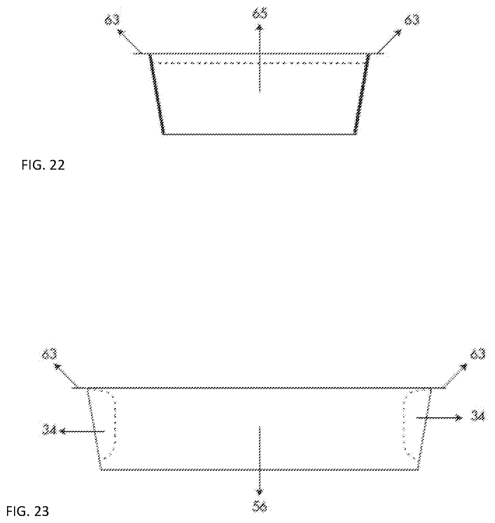

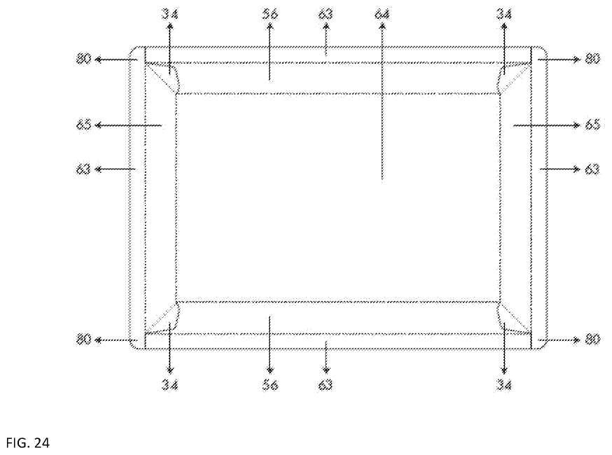

From FIGS. 20 to 24 to the figures of trays without separator.

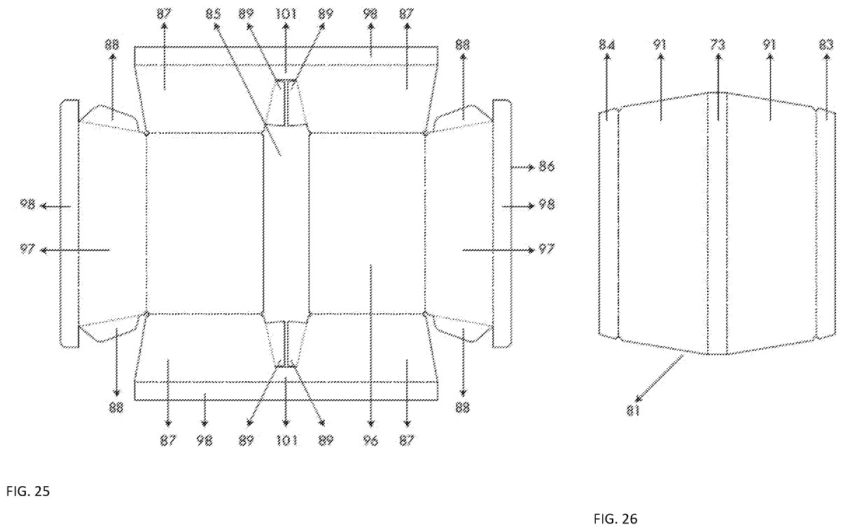

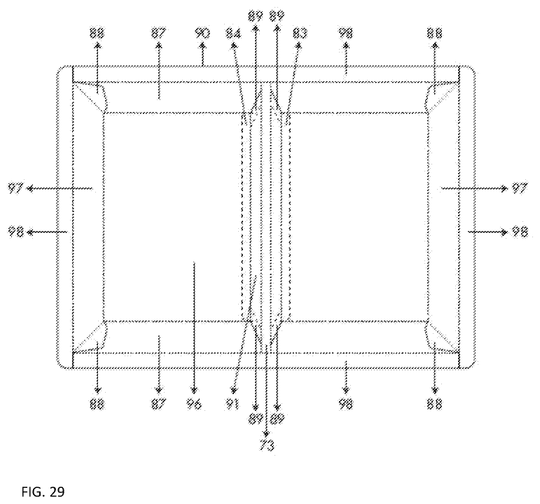

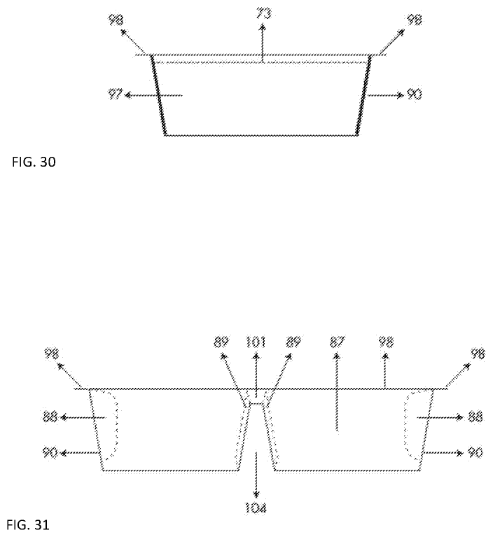

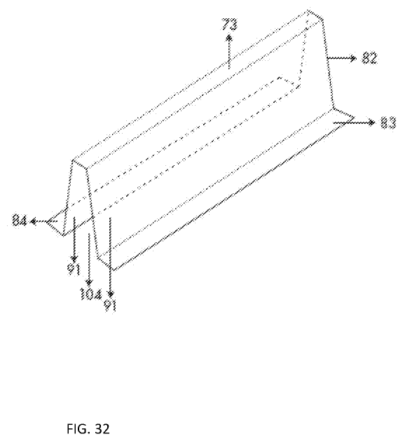

From FIGS. 25 to 32 to the figures of trays with a separator that has a flat surface at the top.

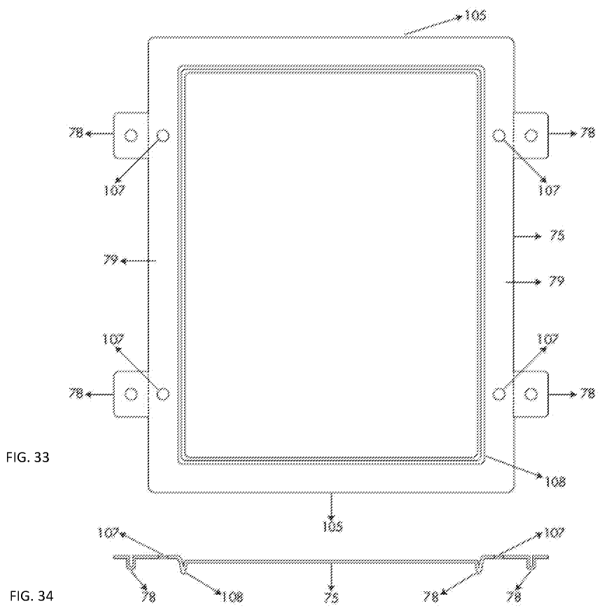

FIGS. 33 and 34 refer to the lid of the trays.

### DETAILED DESCRIPTION OF THE INVENTION

The present invention consists of a machine that produces trays of various materials mainly of cardboard and paperboard, which have or do not have a separator inside the trays and optionally coated with a plastic film inside, which makes them waterproof, these trays store and transport all types of products both solid and liquid. It also consists of the method for obtaining the trays and the trays obtained.

The trays covered with a plastic film are manufactured with the capacity to contain modified atmospheres inside, that is to say, atmospheres with a composition of gases different from that of air, in order to extend the storage time of food products and their conservation. This is done by closing the tray with the technique known as “top seal”.

The trays of the present invention also have a simple closing or capping, without modifying their atmosphere, this by means of a lid made of paper, cardboard, extruded, injected or thermoformed plastic with snaps that close or open according to the need of the user or type of packaging.

The following is a detailed description of the present invention, comprising the apparatus for the manufacture of the trays, the method of operation of the said apparatus and the trays manufactured in the said apparatus.

The description starts with the device for the production of film-coated trays with separator.

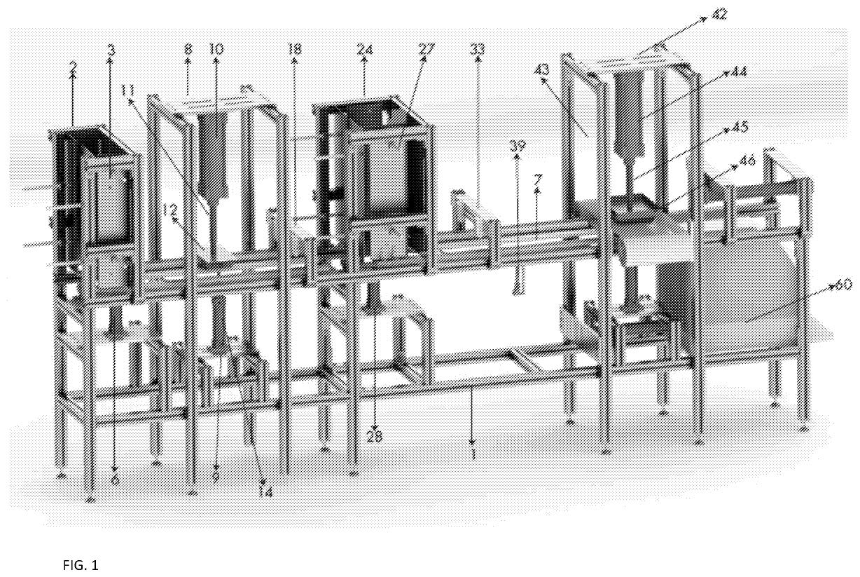

According to FIG. 1, the machine of the present invention comprises a frame (1) on which are assembled essentially seven modules or stations, these stations being the following:

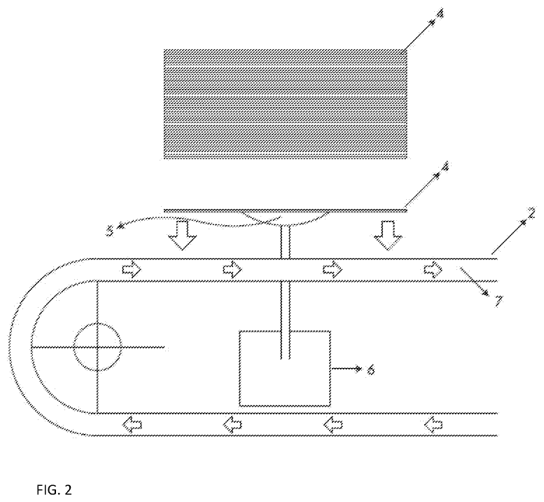

The first station (2) comprises, according to FIGS. 1 and 2, a stacker (3) of the preforms of the separator (4) or (81) of the tray, which are used when the tray has two or more compartments; a suction cup (5) of the preforms of the separator (4) or (81) stacked, connected to a vacuum system (6), to suck the preforms (4) or (81), and a conveyor belt (7) on which the suction cup (5) by an upward and downward movement places the preforms (4) or (81) to advance to the second station (8).

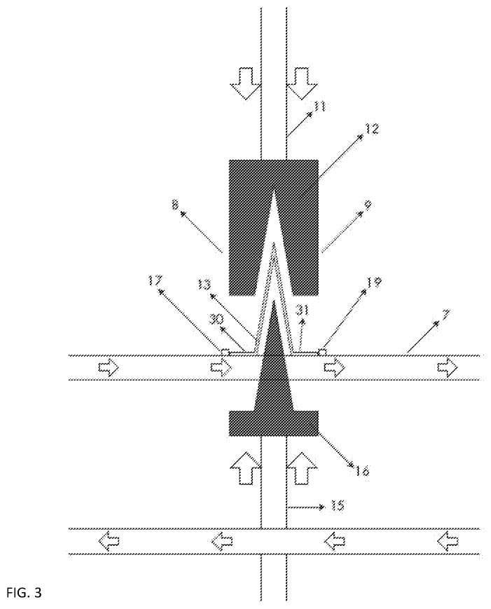

The second station (8), is the station where the tray separator is formed, going from a flat shape (4) or (81) to its final shape (13) or (82), this second station (8), according to FIGS. 1 and 3 is structured with: a double acting pneumatic press (9), which has an upper pneumatic cylinder (10) with an upper piston (11), a die or female mold (12) with the outer shape of the formed separator (13) or (82) at one end of the upper piston (11) a lower pneumatic cylinder (14) with a lower piston (15), a male die or mold (16) with the inner shape of the formed separator (13) or (82) at one end of the piston (15), all these elements cooperate to give the shape to the separator (13) or (82); metal guides (17) and (19) at an interval of the conveyor belt (7) so that the formed separator (13) or (82) maintains its position and does not lose its shape when transported to the third station (18).

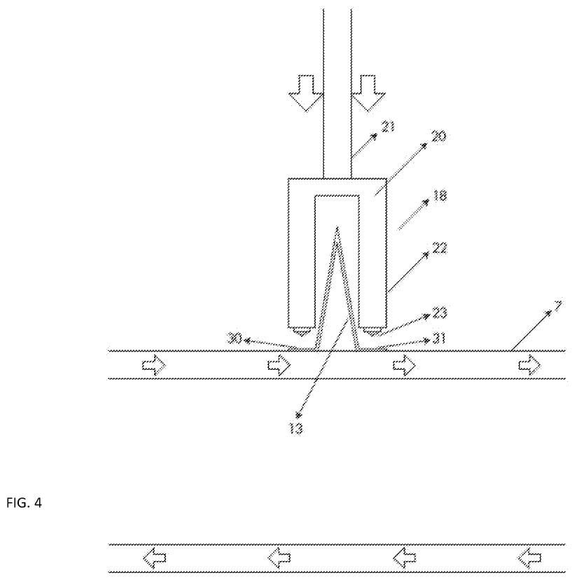

The third station (18), is in which adhesive is applied to the flaps (30) and (31) of the formed separator (13) or to the flaps (83) and (84) of the formed separator (82); it is constituted according to the FIGS. 1 and 4 by an adhesive injector (20), which consists of a vertical bar (21), which has an alternating movement and lateral movements, at one end of the bar (21) is attached a hollow inverted ‘U’ shaped container (22), in which the adhesive is stored at the end of the 2 branches of the inverted “U” are the adhesive applicators (23) which are either pressurized or pneumatic and the adhesive is applied hot or at room temperature at points on the flaps (30) and (31) of the formed separator (13) or on the flaps (83) and (84) of the formed separator (82), the U-shaped container has adapters for applying adhesive to the flaps (70) and (71). Once the adhesive has been applied to the flaps (30) and (31), and (70) and (71), of the formed separator (13), or the flaps (83) and (84) of the formed separator (82), the belt (7) carries it to the next station.

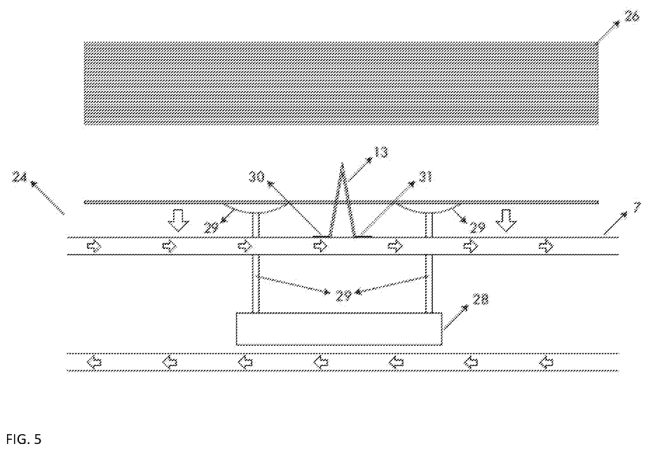

The fourth station (24), refers to FIGS. 1 and 5 among others, in this station the formed separator (13) or (82) is placed in the opening (25) or (85), which is respectively in the middle of the preform of the tray (26) or (86) when it is composed of 2 or more compartments. This station comprises a stacker (27) of the preforms of trays (26) and (86); a vacuum system (28), which has two or more vacuum cups (29) connected to it which suck the preform tray (26) or (86) from the stacker (27), which are extended and previously die cut, and position it so that the formed separator (13) or (82) on the conveyor belt (7) passes respectively through the opening (25) or (85) of the preform tray (26) or (86), until the flaps with adhesive (30) and (31) or (83) and (84) respectively make contact with the outer wall around the opening (25) or (85) of the preform (26) or (86) of the trays, whereby the separator formed (13) or (82) is firmly attached to the preform of trays (26) or (86) respectively, obtaining an assembly (32) or the one formed by the formed separator (82) adhered to the preform of the tray (86), which is transported by the conveyor belt (7) to the fifth station (33).

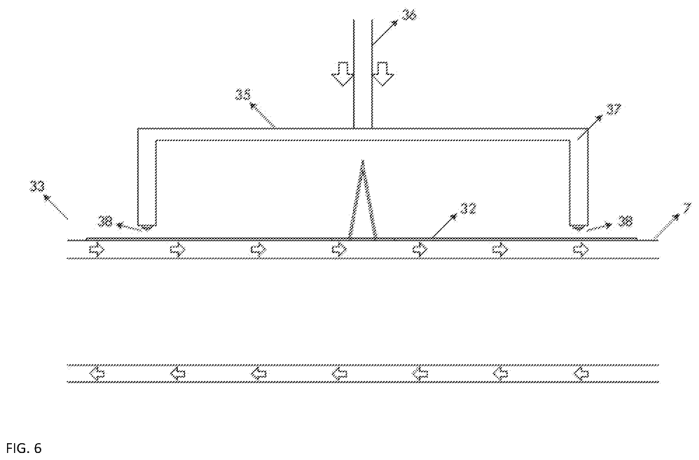

The fifth station (33) refers to FIGS. 1 and 6 among others, is where adhesive is applied to the walls (56) in regions near the flaps (34) of the preform of the trays (26), as well as to the walls (87) in regions near the flaps (88), additionally it is applied to the flaps (89) of the walls (87) of the preform of the trays (86); is constituted according to FIGS. 1 and 6 by an adhesive jet (35), which consists of a vertical bar (36), which has an alternating movement and lateral movements, at one end of the bar (36), there is a U-shaped container with the partially hollow, open and inverted branches (37) where an adhesive is stored, at the ends of each of the 2 branches of the open inverted “U” (37) there are the adhesive applicators (38) which are either pressurized or pneumatic and the adhesive is applied hot or at room temperature at selected points in the areas mentioned above, once the adhesive has been applied, the assembly (32) or the formed separator (82) attached to the preform of the tray (86) is transported by the belt (7) to the sixth station (39).

The sixth station (39) is where the flaps (34) of the preform tray (26) and the flaps (88) and (89) of the preform tray (86) are pre-folded. The sixth station (39) is constituted according to FIGS. 1 y 7 among others, a drive mechanism such as a pneumatic cylinder (76), which detects the position of the preform of the tray, and is provided with a vertical bar (61) that has an alternating movement, which is joined at one end to a mechanism formed by a horizontal bar (41) which has at each end a vertical impeller (62), which are the ones that perform the pre-folding by pushing up the flaps (34) of the pre-form of the trays (26) and the flaps (88) and (89) of the pre-form of the tray (86); a back-up mechanism (40), such as precision machined guides that hold the assembly (32), or the assembly (92) comprising the formed separator (82) attached to the preform of the tray (86), at critical points to prevent the assembly or set from bending in undesirable places; these guides are adjustable; Upon completion of this operation the assembly (32) with the pre-folded flaps (34) or the assembly comprising the formed separator (82) attached to the preform of the tray (86), with the pre-folded flaps (88) and (89) passes to the next station.

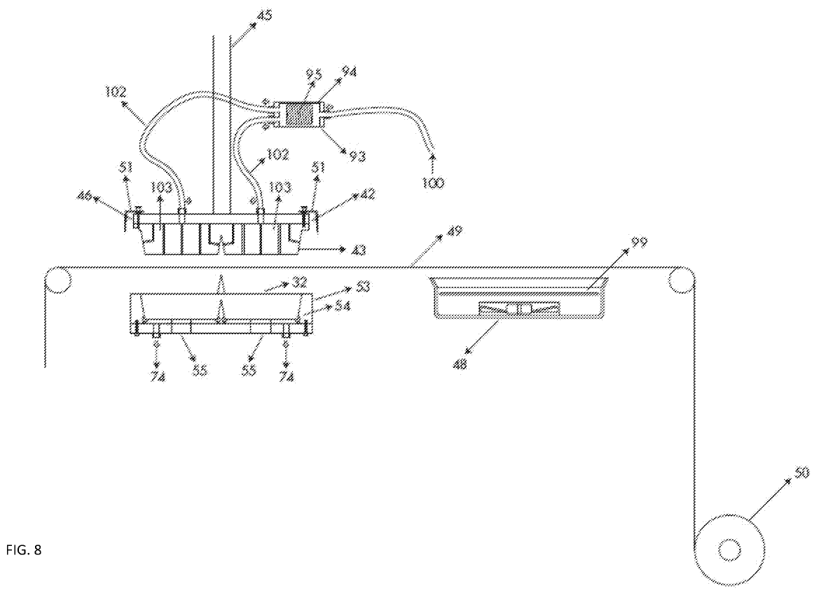

The seventh station (42) is where the final shape is given to the trays and the top surface is coated with a plastic film. The seventh station (42) refers to FIGS. 1 and 8 among others, it is at the end of the conveyor belt (7), it is constituted by a double effect pneumatic press (43), which has an upper pneumatic cylinder (44) and an upper piston (45), which has in one of its ends a mobile counter-mold (46) that has the shape of the inner surface of the trays (47) or (90); a rabbet (106) in a small portion anywhere on the perimeter of the movable backing pad (46) so when the forming and sealing cycle is performed it does not exert pressure between the film and the cardboard just in that area so that the adhesion is less and thus generate a release flap for the film when it has been used and is to be recycled; a perimeter saw (51), comprising a cutting blade (110); a support for the cutting plate (111), and an adjustment bolt (112) for the cutting plate (110), the saw (51) is in a part near the top of the counter-mold, to cut the plastic film each time it is applied, a notch (69) in the mold where the cutting plate (110) penetrates the plastic film; an unwinder (50) for the plastic film, with controlled feed e.g. by means of toothed belts and a perimeter saw (51), comprising a cutting blade (110); a support for the cutting die (111), and an adjustment bolt (112) for the cutting die (110), the saw (51) being located near the top of the counter-mold, to cut the plastic film each time it is applied, a notch (69) in the mold where the cutting die (110) of the plastic film penetrates, a film heating system (49) which consists of two sections, the pre-heating section and the forming section; in the pre-heating section a fan (48) blows air at very low speed through a heating medium (99) such as a set of spiral resistors arranged in an orthogonal grid across the width of the film, so that the forming is carried out in a shorter time; the forming section where the final forming film heating takes place comprises a low speed hot air injection system (93), comprising a chamber (94) containing a spiral resistor (95) or other heating medium, to heat air entering through the duct (100) coming from the pneumatic system of the machine of the present invention, the hot air exiting through the ducts (102) and entering into conduction channels (103) arranged in the counter-mold (46), to direct the air to points selected from the trays (47) and (90), to achieve elongation and adhesion of the plastic film (49); a lower pneumatic cylinder (52), with a lower piston not shown, the piston has at its end a mold (53), fixed, which has the shape of the outer surface of the trays (47) or of the trays (90), this mold (53) cooperates with the counter mold (46) to form the tray (47) or (90); a vacuum bed (54) provided in the mold (53), where the ducts (74) are part of the vacuum system, has air outlets (55) that attract the plastic film (49) to the bottom of the trays, these devices cooperate to shape the trays and coat them with the plastic film (49); the upper piston (45), has an alternate movement, when the counter-mold (46) and the mold (53) are closed they cause the flaps (34) to stay in position and stick to the side walls (56), of the formed trays (47) and (90), also the flaps (88) and (89) stay in position and stick to the walls (87) and (91) respectively, all these flaps can vary in shape and dimension; in addition, the flaps (70) and (71) are glued on the outside of the walls (56) to form the trays (47); an ejection mechanism (57) ejects the trays (47) and (90) thus formed when the counter-mold (46) is opened, additionally a mechanism with suction cups (58) connected to a vacuum system (59) sucks the trays in and the mechanism with suction cups (58) moves so that when the vacuum is suspended, by gravity they drop the trays (47) and (90) into an accumulator of finished trays (60).

The following is a description of the device for manufacturing trays with a separator, without a plastic film coating.

When the trays are formed without the plastic film coating (49), the apparatus at stations one through seven is the same, except that at station seven (42) not all the parts that form that station are used, the seventh station (42), where the trays are not covered with a plastic film, is described below:

The seventh station (42) is where the final shape is given to the trays. The seventh station (42) refers to FIGS. 1 and 8, among others, is located at the end of the conveyor belt (7), it consists of a double-acting pneumatic press (43), which has an upper pneumatic cylinder (44) and an upper piston (45), which has at one end a movable counter-mold (46), which has the shape of the inner surface of the trays (47) or (90) and with a rabbet (106); a lower pneumatic cylinder (52), with a lower piston not shown, the piston has at its end a fixed mold (53), which has the shape of the outer surface of the trays (47) or (90), this mold (53) cooperates with the counter mold (46) to form the tray (47) or (90); the upper piston (45) has an alternating movement, as the counter-mold (46) and the mold (53) close, causing the flaps (34) and (88) to stay in position and stick to the side walls (56) and (87) respectively of the formed trays (47) and (90); also the flaps (88) and (89) stay in position and stick to the walls (87) and (91) respectively; furthermore the flaps (70) and (71) stick to the outside of the walls (56) to form the trays (47); an ejection mechanism (57) ejects the trays (47) or (90) thus formed when the counter-mold (46) is opened; a mechanism comprises suction cups (58) connected to a vacuum system (59) which suck the tray in; the mechanism (57) passing through the air outlet ducts (55) pushes the trays (47) or (90), the suction cups (58) with the trays attached move and by gravity drop the trays (47) or (90) into an accumulator of finished trays (60).

In one modality of the present invention, the apparatus manufactures trays that do not have a separator as shown in FIG. 21, and that are covered with a plastic film, in this case the parts in which it makes the manufacture of said trays, are from the fourth station (24) to the seventh station (42), according to the following:

The fourth station (24), refers to FIGS. 1 and 5. This station comprises a stacker (27) of the preforms (66) of the trays (67); a vacuum system (28), which has 2 or more suction cups (29) connected that suck the tray preform (66) from the stacker (27), which is extended and previously rinsed and printed, and place it on the conveyor belt (7) that takes it to the fifth station (33).

The fifth station (33) refers to FIGS. 1 and 6, it is where adhesive is applied to the walls (56) in an area near the flaps (34) of the preform of the trays (66); it is constituted according to FIGS. 1 and 6 by an adhesive injector (35), which consists of a bar (36), which has an alternating movement and lateral movements, at one end of the bar (36), there is an open inverted “U” shaped container (37) where the adhesive is stored, at the ends of each of the 2 branches of the open inverted “U” (37), there are the adhesive applicators (38) which are either pressurized or pneumatic and the adhesive is applied hot or at room temperature at selected points on the walls (56) in an area near the flaps (34) of the preformed trays (66), once the adhesive has been applied, the preformed trays (66) are transported along the belt (7) to the sixth station (39).

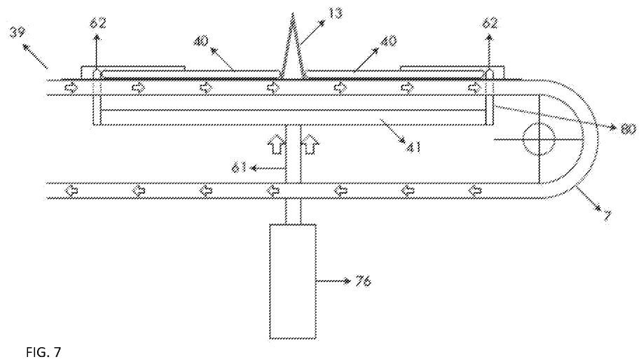

The sixth station (39) is where the flaps (34) of the preform of the tray (66) are pre-folded. The sixth station (39) is constituted according to FIGS. 1 and 7 by: a driving mechanism (76) such as a pneumatic cylinder, which detects the position of the preform of tray without separator (66); connected to a vertical bar (61) which has an alternate movement, which is joined at one of its ends with a mechanism formed by a horizontal part (41) which has at each end a vertical drive (62), which are the ones that perform the pre-folding by pushing up the flaps (34) of the preform of tray (66); a support mechanism-against (40), such as precision machined guides hold the preform of the tray (66) at critical points to prevent the assembly from bending in undesirable places, these guides are adjustable; the preform of the trays (66) with the pre-folded flaps (34), passes to the next station.

The seventh station (42) is where the final shape is given to the trays and the top surface is coated with a plastic film. The seventh station (42) refers to FIGS. 1 and 8 and is at the end of the conveyor belt (7). It is made up of a double-acting pneumatic press (43), which has an upper pneumatic cylinder (44) and an upper piston (45), which has a mobile counter-mold (46) at one end that has the shape of the inner surface of the trays (67); a perimeter saw (51), close to the edge of the counter-mold (109), comprising a cutting die (110), a cutting die support (111), and an adjustment bolt (112) for the cutting die (110), the saw (51) being in a part close to the top of the counter-mold, to cut the plastic film each time it is applied, a notch (69) in the mold where the cutting die (110) penetrates the plastic film; a notch (69) in the mold where the film cutting element penetrates; a film unwinder (50) with controlled feed for example by toothed belts and a servo motor; a film heating system (49) consisting of two sections, the pre-heating section and the forming section; in the preheating section a fan (48) blows air at a very low speed through a heating medium such as a set of helical resistors arranged in an orthogonal grid across the width of the film, thus allowing the film to be formed in a shorter time; the forming section where the final forming film heating takes place comprises a low speed hot air injection system (93), comprising a chamber (94) containing a spiral resistor (95) or other heating medium, to heat air coming from the pneumatic system of the machine of the present invention, the hot air exits through the ducts (102) and enters into conduction channels (103) arranged in the counter-mold (46), to direct the air to selected points of the trays (67), to achieve elongation and adhesion of the plastic film (49); a lower pneumatic cylinder (52), with a lower piston not shown, the piston has at its end a fixed mold (53), which has the shape of the outer surface of the trays (67), this mold (53) cooperates with the counter-mold (46) to form the tray (67) a vacuum bed (54) provided in the mold (53), where the ducts (74) are part of the vacuum system, has air outlets (55) that attract the plastic film (49) to the bottom of the trays, these devices cooperate to shape the trays and coat them with the plastic film (49); the upper piston (45), has an alternate movement, as the counter-mold (46) and the mold (53) close, causing the flaps (34) to stay in position and stick to the side walls (56) of the formed trays (67), these flaps can vary in shape and dimension; An ejection mechanism (57) ejects the formed trays (67) when the counter-mold (46) is opened, additionally a suction cup mechanism (58) connected to a vacuum system (59) sucks the tray (67) in and the suction cup mechanism (58) moves so that by gravity they drop the trays (67) into an accumulator of finished trays (60).

When the trays are formed without the separator and without the plastic film coating (49), the apparatus in the first to seventh stations is the same, except that in the seventh station (42) not all the parts that form that station are used. The following describes the seventh station (42) in which the trays are not coated with a plastic film.

The seventh station (42) is where the final shape is given to the trays. The seventh station (42) refers to FIGS. 1 and 8, it is located at the end of the conveyor belt (7), it consists of a double acting pneumatic press (43), which has an upper pneumatic cylinder (44) and an upper piston (45), which has at one end a movable counter-mold (46), which has the shape of the inner surface of the trays (67); a lower pneumatic cylinder (52), with a lower piston not shown, the piston has at its end a fixed mold (53), which has the shape of the outer surface of the trays (67), this mold (53) cooperates with the counter mold (46) to form the tray (67); the upper piston (45) has an alternating movement, as the counter-mold (46) closes and the mold (53) causes the flaps (34) to remain in position and stick to the side walls (56) of the formed trays (67), these flaps can vary in shape and dimension; an ejection mechanism (57) enters through the air outlet ducts (55) and ejects the trays (67) thus formed when the counter-mold (46) is opened; a mechanism with suction cups (58) connected to a vacuum system (59) sucks the tray in; the mechanism (57) passing through the air outlet ducts (55) pushes the trays (67), the suction cups (58) with the trays attached move and by gravity when the vacuum is suspended drop the trays (67) into an accumulator of finished trays (60).

Within the scope of the present invention, the seventh station (42) is to be used directly with other machines that manufacture trays separately, so that in said seventh station (42) the operations described in the present patent application are carried out.

As a mode, in the fourth station (24) is supplied with trays formed so that the fifth (33) and sixth (39) stations remain non-functional.

Another modality is that because the speed of coating the trays with a plastic film in the seventh station (42), could be lower than the other stations, you have more than one seventh station (42) working in parallel.

The apparatus of the present invention is modular, so that during its operation all the stations work, or some of them work, and some stations receive already formed trays or separators.

The method for the manufacture of the separator trays, coated with a plastic film, with the apparatus of the present invention, is described below:

In the first station (2), in a first stage, the machine of the present invention is fed with the preforms already die cut, either from the separator (4) or the separator (81) in the stacker or accumulator (3) of the first station (2) and the preforms of the tray (26) or of the tray (86) in the stacker or accumulator (27) of the fourth station (24). In a second stage, in the first station (2) a suction cup (5) takes the preform (4) from the separator or preform (81) and places it on a conveyor belt (7), which moves one of these preforms to a second station (8).

The second station (8) is where the separator (13) or (82) of the trays is formed, and is illustrated in FIGS. 1 and 3. In a first stage the preform of the separator (4) or of the separator (81) is transported by the belt (7) until it is placed between the die or female mold (12) that has the exterior form of the separator (13) and the die or male mold (16) that has the interior form of the separator (13) of the double action pneumatic press (9), These dice are interchangeable for others, one being the female die (12) which has the outer shape of the separator (82) and the male separator (16) which has the inner shape of the separator (82); in a second stage the press (9) goes into operation and closes the dies or female mold (12) and male mold (16) to assemble the separator, resulting in the formed separator (13) or formed separator (82); in a third stage, the formed separator (13) or (82) is positioned between metal guides (17) and (19) placed on the conveyor belt (7), so that the formed separator (13) or (82) maintains its position and does not lose its shape when transported on the belt (7) to the third station (18).

At the third station (18), according to FIGS. 1 and 4, adhesive is applied to the formed separator (13) or the formed separator (82). In the first station, the adhesive injector (20), which has the shape of an inverted “U” (22) and adhesive applicators (23), which are pressure or pneumatic applicators, are used. Once the flaps (30) and (31) or (83) and (84) are in position, only the injector (20) needs to be approached and a slight pressure applied with the applicators (23) which can be pressure or pneumatic applicators, for injecting hot-melt or room-temperature adhesive at selected locations on the flaps (30) and (31) or (83) and (84) for optimum bonding, whereby the formed separator (13) or (82) is ready to adhere to the outer surface of the preform in the trays (26) or (86), on the perimeter of the opening (25) of the preform in the tray (26) or on the perimeter of the opening (85) of the preform (86); the adapters of the U-shaped container are used to apply adhesive to the flanges (70) and (71); when the formed separator (13) or (82), has the adhesive placed on the flaps (30) and (31), (70) and (71), or (83) and (84), by means of the conveyor belt (7) it advances to the fourth station (24).

In the fourth station (24), according to FIGS. 1 and 5, among others, the separator (13) or (82) is placed in the opening (25) or (85) respectively that is in the middle of the preform of the tray (26) or (86) when it is composed of 2 or more compartments; in a first stage, a vacuum system (28) having two or more vacuum cups (29) connected, vacuums an extended preform of the tray (26) or (86), previously die cut from a stack of preforms, and places it in a position where the formed separator (13) or (82) is on the conveyor belt, passes through the opening (25) or (85) respectively of the preform trays (26) or (86), until the flaps with adhesive (30) and (31) make contact with the outer wall around the opening (25) of the preform (26) of trays, whereby the separator (13) is firmly attached to the outer surface of the preformed tray (26), forming an assembly (32), or until the adhesive flaps (83) and (84) contact the outer wall around the opening (85) of the preform (86) of the tray, whereby the separator (82) is firmly attached to the outer surface of the preformed of the tray (86), forming an assembly (92); In a second stage, the conveyor belt (7) leads the assembly (32) or the set (92) to the fifth station (33).

In the fifth station (33), according to FIGS. 1 and 6, among others, adhesive is applied to various parts of the preform of trays; the following method consists of a first stage in which the bar (36) makes an alternating movement, that is to say, down and up, as well as lateral movements, so that the adhesive injector (35), with the adhesive applicators (38) of the inverted “U” arms (37), exerts slight pressure on the walls (56) of the preform of the tray (26) in an area close to the flaps (34), or on the walls (87) in an area close to the flaps (88), as well as on the flaps (89) on the walls (87), the applicators are pressure or pneumatic, the above so that the hot-melt or room-temperature adhesive is applied at selected points on the walls and flaps mentioned above, for optimum bonding; in a second stage, once the adhesive has been applied, the bar (36) raises the adhesive nozzle (35); the formed separator (13) firmly attached to the preform (26) forming the assembly (32) or the set (92), is transported by the belt (7) to the sixth station (39) for subsequent forming.

The method that is carried out in the sixth station (39) has the purpose of having the flaps of the preforms of the trays pre-folded so that when entering the forming of the next station, the order of forming of the trays is controllable, the above having as reference the FIGS. 1 and 7, among others; the stages of the method that is carried out in this station are the following: In a first stage, a support mechanism is placed against (40), such as aluminum guides machined to prevent the assembly (32) or the set (92) from bending in undesired places, these guides are adjustable on the flat parts of these assemblies; in a second stage, the vertical bar (61), which makes an alternating movement, is moved upwards by operating a drive mechanism, which is a pneumatic cylinder (76), that senses the position of the assembly (32) or the assembly (92) and when in position, the mechanism formed by a horizontal bar (41) which is attached to the bar (61), and 2 or more vertical drives (62) at the ends of the bar (41), are operated by pushing the flaps (34) of the assembly (32) or the flaps (82) and (89) to pre-fold them, to control the folding in the next station, in a third stage the support mechanism against (40) is removed, and the bar (61) performs a downward movement, whereby the assembly (32) with the pre-folded flaps (34) or the assembly (92) with the pre-folded flaps (88) and (89), is transported by the belt (7) to the next station.

The method that is carried out in the seventh station (42), is to give the final shape to the trays, as well as to coat the inner surface of the trays and the outer flanges with a plastic film, has as reference the FIGS. 1 and 8, among others, the seventh station (42) is at the end of the conveyor belt (7); the stages of the method carried out in this station are the following: in the first stage the plastic film (49) is preheated by a fan (48) blowing air at very low speed through a heating medium (99), such as a set of spiral resistors arranged in an orthogonal grid across the width of the film, This is to make the molding process less time-consuming, thereby raising the temperature of the plastic film (49) so that it is malleable, the film (49) is supplied by a unwinder (50) at a controlled feed rate by means for example toothed belts and a servo motor; in the second stage the assembly (32) or the assembly (92) is placed at the entrance to the mold (53), the counter-mold (46) and the plastic film (49) is placed on top of the assembly (32) or the assembly (92); in the third stage the final heating of the molding film is carried out by means of a low speed hot air injection system (93), comprising a chamber (94) containing a spiral resistor (95) or other heating medium, to heat air coming from the pneumatic system of the machine of the present invention, and entering through the duct (100), the hot air exits through the ducts (102) and enters into conduction channels (103) arranged in the counter-mold (46), to direct the air to selected points in the trays (47) and (90), to achieve elongation and adhesion of the plastic film (49); in the fourth stage, the upper piston (45) makes a downward movement with which the assembly (32) or the set (92) is pressed by the counter-mold (46) which is mobile, against the mold (53) which is fixed, making the flaps stay in position and stick to the walls (56) of the tray (47), in addition the tabs (70) and (71) stick to the outside of the walls (56) to form the trays (47); or by having the flaps (88) and (89) stay in position and stick to the walls (87) and the wall (91) respectively, the latter being the outer wall of the separator (82); all these flaps may vary in shape and dimension; the above in synchronization with the suction and cutting of the film (49) in addition to pressing the plastic film against the tray (47) or the tray (90) at the edges to make the seal on the tray tabs so as not to allow leakage in the suction of the rest of the film.

The counter-mold (46) in charge of forming the tray and pressing the film inside has a rebate (106) in a small portion anywhere on the perimeter of the counter-mold (46) in the section that makes pressure on the film (49) so that when it makes the forming and sealing cycle, it does not make pressure between the film and the cardboard just in the area of the rebate (106) so that the adhesion is less and thus generate a flap of detachment of the film when it has been used and you want to recycle; with these operations the tray is shaped while the film (49) is adhered to the tray (47) and the film (49) to the tray (90) because the film is thermo adhesive, during this stage the film (49) is sucked by the vacuum bed (54) where the ducts (74) are part of the vacuum system, to the bottom (64) of the tray (47) or to the bottom (64) of the tray (90), Because the vacuum bed (54) sucks air through holes previously arranged at different points in the bottom (64) of the tray (47) or the tray (90), which can vary in size and position, even if the material is sufficiently porous no holes are made in the tray cardboard; the excess film (49) is trimmed synchronously around the tray (47) or the tray (90) by a perimeter saw (51), one type of saw used in the present invention is the one mounted on spring-loaded guides located at the top of the counter-mold (46) and which keeps it elevated, when the counter-mold (46) is lowered, a lever mechanism is operated which causes the saw to lower and cut the plastic; when the counter-mold (46) returns to its position, the lever mechanism contracts and returns the saw to its raised position, ready for the next operation. After the operations performed previously, the upper piston (45) makes an upward movement, thus freeing a space on the mold (53) containing the formed tray (47) or the tray (90); in the fifth stage an ejection mechanism (57) enters the mold (53) through the ducts (55) and pushes the tray (47) or the tray (90) upwards towards the outside of the mold (53), additionally a mechanism with suction cups (58) connected to a vacuum system (59) sucks the tray, and the mechanism with suction cups (58) moves so that when the vacuum is interrupted, by gravity they drop the trays (47) or (90) into an accumulator of finished trays (60).

With the method described above are manufacture the trays (47) which have a formed separator (13), attached to the bottom (64) of the tray on the outside; the trays (90) are also manufactured which have a separator with a flat top wall (73), attached to the bottom of the tray (90) on the outside and attached to the side walls (87) of the tray (90) on the outside, so that the trays have 2 or more compartments and are coated with plastic film.

The method for manufacturing trays with separator and without the film coating; for the first to sixth stations is the same as described above, what is different is the method for the seventh station (42), which is carried out as follows.

The method performed in the seventh station (42) is to give the final shape to the trays, it has as reference the FIGS. 1 and 8 among others, the seventh station (42) is at the end of the conveyor belt (7); the stages of the method performed in this station are the following: in the first stage the assembly (32) or the set (92) is placed at the entrance of the mold (53), the counter-mold (46) is placed above the assembly (32) or the set (92) in the second stage, the upper piston (45) makes a downward movement which causes the assembly (32) or the assembly (92) to be pressed by the counter-mold (46) which is movable, towards the mold (53) which is fixed, causing the flaps (34) to remain in position and stick to the walls (56) of the tray (47), or by having the flaps (88) and (89) stay in position and stick to the walls (87) and the wall (91), respectively, the latter being the outer wall of the separator (82), all these flaps may vary in shape and dimension; after the above operations the upper piston (45) makes an upward movement, thus freeing a space on the mold (53) containing the formed tray (47) or the tray (90); in the third stage an ejection mechanism (57) enters the mold (53) through the ducts (55) and pushes up the tray (47) or the tray (90) to the outside of the mold (53), additionally a mechanism with suction cups (58) connected to a vacuum system (59) sucks the tray, and the mechanism with suction cups (58) moves so that when the vacuum is interrupted, by gravity they drop the trays (47) or (90) into an accumulator of finished trays (60).

The method described above is used to manufacture the trays (47) which have a formed separator (13), attached to the bottom (64) of the tray on the outside; it is also used to manufacture the trays (90) which have a separator with a flat top wall (73), attached to the bottom of the tray (90) on the outside and attached to the side walls (87) of the tray (90) on the outside, by means of the flaps (89) the trays that are formed this way have 2 or more compartments.

The method for the manufacture of trays (67), according to FIG. 17, which do not have a formed separator (13), and with a plastic film coating is carried out partly using the apparatus of FIG. 1, where the method starts from the fourth station (24).

In the fourth station (24) according to FIGS. 1 and 5 among others, the method is described as follows: in a first stage a vacuum system (28) with 2 or more vacuum cups (29) connected, sucks an extended preform of tray (66), previously die cut and printed, from a stack of preforms and places it in a position where the conveyor belt (7) leads the preform of tray (66) to the fifth station (33).

In the method performed in the fifth station (33), according to FIGS. 1 and 6 among others, adhesive is applied to the walls (56) in areas near the flaps (34), of the preform of the tray (66); the method followed consists of the following stages, in the first stage the bar (36) makes an alternating movement, that is to say, down and up, as well as lateral movements, so that the adhesive injector (35) makes a slight pressure with the adhesive applicators (38) of the inverted “U” arms (37) on the walls (56) in an area close to the flaps (34) of the preform of the trays (66), the adhesive applicators are either pressure or pneumatic, the latter so that the hot-melt or room-temperature adhesive is applied at selected points on the walls (56) for optimum bonding; in a second stage, once the adhesive has been applied to the walls (56) of the preform of the trays (66), the preform is transported by the belt (7) to the sixth station (39) for further forming.

The method that is carried out in the sixth station (39) has the objective that the flaps (34) of the preform of the tray (66) are pre-folded so that when entering the forming of the next station, the order of forming of the tray (67) is controllable, the above having as reference the FIGS. 1 and 7, among others; the stages of the method that is carried out in this station are the following: In a first stage, a support mechanism is placed on the preform without separator (66), such as aluminum guides machined to prevent the preform (66) from bending in undesirable places. These guides are adjustable on the flat parts of the preform; in a second stage, the bar (61) which makes an alternating movement is moved upwards by means of a drive mechanism, which is a pneumatic cylinder, that senses the position of the tray preform without separator (66) and when in position, the mechanism formed by a horizontal bar (41) which is attached to the bar (61), and its 2 or more vertical drives (62) at the ends of the bar (41), are activated, push the flaps (34) of the pre-form tray (66) to pre-fold them in order to control the folding in the next station, in a third stage the support mechanism-counter (40) is removed, and the bar (61) makes a downward movement, with which the pre-form of tray without separator (66) with the pre-folded flaps (34) is transported by the belt (7) to the next station.

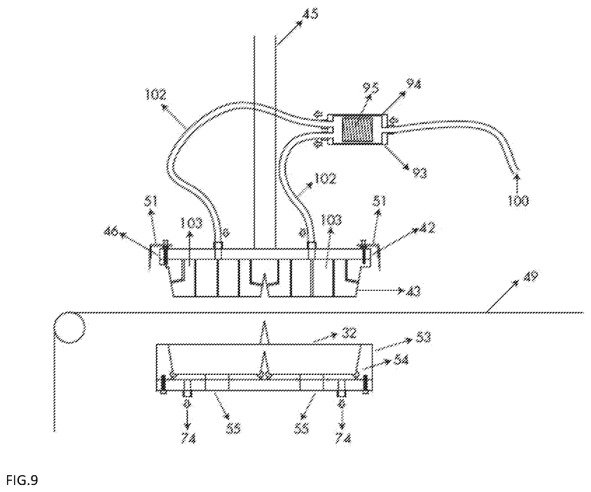

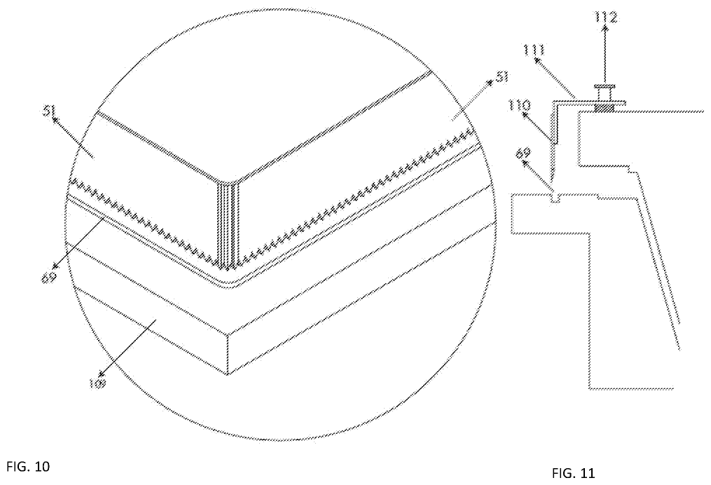

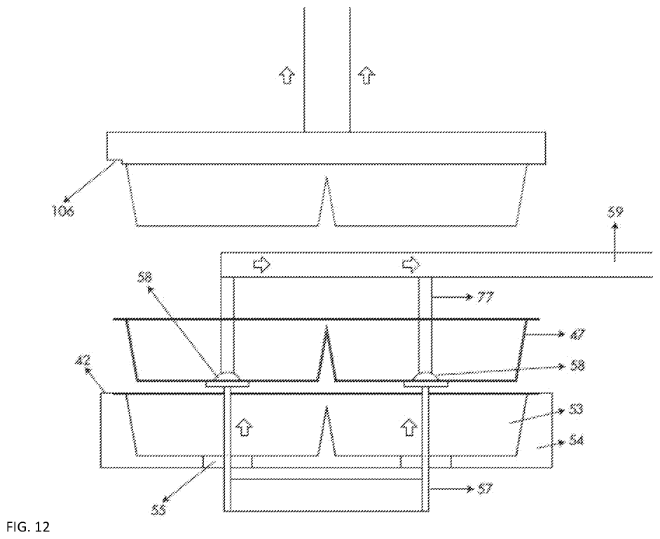

The method used in the seventh station is to give the final shape to the trays, as well as to coated the inner surface of the trays and the outer flanges with a plastic film, using as reference the FIGS. 1, 8 and 9 and 10 to 22; the stages of the method used in this station are the following: in a first stage the plastic film (49) is preheated by a fan (48) which blows air at a very low speed through a heating medium such as a set of spiral resistors arranged in an orthogonal grid across the width of the film This is to make the molding process less time-consuming, thereby raising the temperature of the plastic film (49) so that it is malleable, the film (49) is supplied by a unwinder (50) at a controlled feed rate, for example by means of toothed belts and a servo motor; in the second stage the preform without separator (66) is placed at the inlet to the mold (53), the counter-mold (46) and the plastic film (49) are placed on top of the preform without separator (66); in the third stage the final heating of the molding film is carried out by a low-speed hot-air injection system (93) comprising a chamber (94) containing a spiral resistor (95) or other heating medium, to heat air entering through the duct (100) coming from the pneumatic system of the machine of the present invention, the hot air exits through the ducts (102) and enters into conduction channels (103) arranged in the counter-mold (46), to direct the air to selected points of the trays (67), to achieve elongation and adherence of the plastic film (49); in the fourth stage the upper piston (45) makes a downward movement so that the preform of tray without separator (66) is pressed towards the mold (53) by the counter-mold (46) making the flaps (34) stay in position and stick to the walls (56) of the tray (67) these flaps can vary in shape and dimension, in synchronization with the suction and cutting of the film (49) in addition to pressing the plastic material against the tray (67) to make the seal on the tabs of the tray (63), having an area where the adherence of the film (49) is lower due to the rebate (106) on the counter-mold (46); which gives shape to the tray (67) while the film (49) adheres to the tray (67) because the film is thermo-adhesive, during this stage the film (49) is sucked by the vacuum bed (54), where the ducts (74) are part of the vacuum system, towards the bottom of the tray (64) because the vacuum bed (54) sucks air through the holes previously arranged in different points of the tray (64), which can vary in size and position, even if the material is sufficiently porous no holes are made in the film (49) around the tray (67) by a notched system (51), which cuts the film (49) either hot or cold, after the operations carried out previously the upper piston (45) makes an upward movement which frees up a space on the mold (53) containing the formed tray (67); in the fifth stage a mechanism (57) enters through the ducts (55) pushing upwards the tray (67) towards the outside of the mold (53), where a transport device (77) of the formed trays (67), provided with a suction device (59) makes contact with the bottom of the tray (67) and sucks it in, the suction cup mechanism (58) moves so that when the vacuum is interrupted, by gravity they drop the trays (67) into an accumulator of finished trays (60), thus ending the method of manufacture of the trays of the present invention in which the trays (67) do not have a formed separator.

The method for manufacturing trays without separator and without the film coating, for the first to sixth stations is the same as described for the immediate previous method, what is different is the method for the seventh station (42), which is performed as follows.

The method that is carried out in the seventh station (42) is to give the final shape to the trays without separator and without plastic film coatings, it has as reference the FIGS. 1 and 8, among others, the seventh station (42) is at the end of the conveyor belt (7); the stages of the method that are carried out in this station are the following: in a first stage the preform of tray without separator (66) is placed at the entrance of the mold (53), the counter mold (46) is placed above the preform of tray without separator (66); In the second stage, the upper piston (45) makes a downward movement, so that the preform without separator (66) is pressed by the counter-mold (46) that is mobile, towards the mold (53) that is fixed, making the flaps (34) stay in position and stick to the walls (56) of the tray (67). After the operations made previously, the upper piston (45) makes an upward movement, so that a space is released on the mold (53) containing the formed tray (67); in the third stage an ejection mechanism (57) enters through the ducts (55) and pushes up the tray (67) towards the outside of the mold (53), additionally a mechanism provided with suction cups (58) connected to a vacuum system (59) makes contact with the bottom of the tray (67) and sucks it in, the suction cup mechanism (58) moves so that when the vacuum is interrupted, by gravity they drop the trays (47) into an accumulator of finished trays (60), thus ending the method of manufacture of the trays of the present invention in which the trays (67) do not have a formed separator and do not have a plastic film coating.

In the manufacture of the above trays, either with or without a separator and with a film coating, plastic films are used which are treated with heat-sealing lacquers. Various materials are also used, mainly cardboard and paperboard, which are treated with heat-sealing lacquers on the surface forming the inside of the trays, in order to obtain sufficient adhesion of the plastic films on the trays for the purposes for which they are intended.

The trays of the present invention are formed from preforms, a first tray is formed from the preform in FIG. 13 corresponding to a tray with separator, and from the corresponding preform in FIG. 14 corresponding to the separator; the preform of the tray in FIG. 13, identified with the reference number (26), contains the following parts: a bottom (64) and side walls (56), as well as sidewalls (65); tabs (63) on the upper edge of both the walls (56) and the sidewalls (65), formed by a fold towards the outside, all made of the same material which may be cardboard and paperboard flaps (34) which project outwards from the walls (65), these flaps when the tray is formed (47) are glued on the outside to the inside of the walls (56) which causes the trays (47) to be structured as a unit which maintains its shape with or without the plastic film (49) adhering to the inside of the tray; an opening (25) which is in the middle of the preform (26), may also be in a different position, comprising both part of the bottom (64) and part of the length of the walls (56) of the preform (26). The preform of the separator in FIG. 14 identified by the reference number (4) contains the following parts: 2 side walls (68), which are continued in tabs (30) and (31), which are the ones that stick to the bottom of the tray when it is formed, the side walls (68) are continued towards the front with tabs (70) and in the back with tabs (71), the tabs (70) and (71) have in the middle a reduced separation, these tabs are the ones that stick to the walls (56) of the tray from the outside; the side walls (68) of the preform (4) when folded form a corner (72); the two preforms mentioned above are die-cut and, if necessary, printed and treated with a heat-sealing lacquer on one side before entering the tray-making machine.

Another mode of preforms of a tray and a separator from which a tray with separator is formed, are shown in FIGS. 25 and 26, in FIG. 25 the preform of the tray is shown and in FIG. 26 the one of the separator; the preform of the tray is identified with the No. (86), this preform comprises: a bottom (96), side walls (87), as well as sidewalls (97); tabs (98) on the upper edge of both walls (87) and sidewalls (97), formed by a fold towards the outside, all of the same material which may be cardboard and paperboard; flaps (88) which project outwards from the walls (97), these flaps, when the tray is formed (90), are glued on the outside to the inside of the walls (87) which causes the trays (90) to be structured as a unit which maintains its shape with or without the plastic film (49) adhering to the inside of the tray; an opening (85) which is in the middle part of the preform (86), may also be located in parts other than the middle part of the preform (86); flaps (89) which are an extension of the walls (87), which are in a position that is the continuation of the opening (85), which can be folded and which when the tray (90) is formed adhere to the outer wall of the formed separator (82); a distance (101) between the line where it folds the flaps (98) and the top of the flaps (89).

The preform of the separator is identified in FIG. 26, with the reference number (81), comprises the following parts: a flat wall (73), between 2 walls (91), the 2 walls can be bent where the bending line is at the border with the flat wall (73); flaps (83) and (84) at the ends of the walls (91) which when the tray is formed adhere to the bottom of the tray by its outer wall.

Another type of preform is illustrated in FIG. 20, with the reference number (66), as can be seen in this figure the preform has no space for a separator so the tray that is formed is without a separator; this preform comprises the following parts: a bottom (64) and side walls (56), as well as sidewalls (65); tabs (63) on the upper edge of both walls (56) and sidewalls (65), formed by a bend towards the outside of the same material; flaps (34) which project outwards from the walls (65), these flaps, when the tray is formed (67), are attached on the outside to the inside of the walls (56) which causes the trays (67) to be structured as a unit which maintains its shape with or without the plastic film (49) on the inside of the tray; the flaps (63) have the function of supporting the lid which is placed on the trays when they are formed.

A first type of trays which are manufactured in accordance with the apparatus and method of the present invention, refers to FIGS. 21 to 24, in these trays identified by the number (67) there is no separator; it comprises a bottom (64) and side walls (56), as well as side walls (65) which may be totally vertical or inclined; some tabs (63) on the upper edge of both the walls (56) and the walls (65), formed by a bend towards the outside; the trays (67) are made of various materials mainly of cardboard and paperboard; flaps (34) projecting outwards from the walls (65), these flaps as shown in FIG. 21 are attached on the outside to the inside of the walls (56) resulting in the trays (67) being structured as a unit which retains its shape with or without the plastic film (49) attached to the inside of the unit.

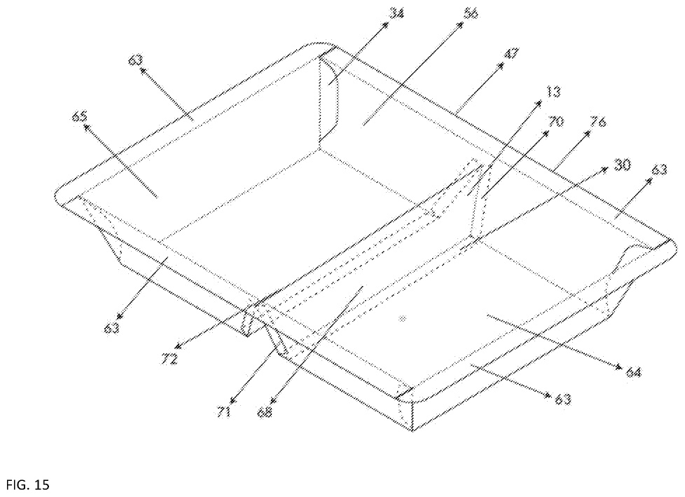

Other trays which are manufactured in accordance with the apparatus and method of the present invention, refer to FIGS. 15 to 19, in these trays identified by the number (47) there does exist a separator; it comprises a bottom (64), side walls (56) and sidewalls (65), which may be totally vertical or inclined; some tabs (63) on the upper edge of both the walls (56) and the walls (65) are formed by a fold towards the outside, all of the same material preferably cardboard and paperboard; flaps (34) projecting outwards from the walls (65), these flaps when the tray is formed (47) are glued on the outside to the inside of the walls (56), resulting in the trays (47) being structured as a unit which retains its shape with or without a plastic film (49) adhering to the entire inner surface of the tray and to that of the flaps (63); a separator formed (13), which is attached to the bottom of the tray (47), on the outside of the tray (47), the separator (13) is formed by 2 sloping walls (68), which are continued in some tabs (30) and (31), which are the ones that are attached to the bottom of the tray (47), On the outside, the side walls (68) are continued towards the front with some tabs (70) and on the back with some tabs (71), these are the ones that stick to the walls (56) of the tray (47), on the outside; the side walls (68) of the separator (13) when they are bent form a vertex (72), the separator (13), divides in 2 spaces or compartments a tray (47), resulting among other aspects to avoid that products of different nature are mixed, the spaces in which the tray (47) is divided can be of equal or different magnitude, that is to say the separator (13) is in different positions along the tray, also the tray has 2 or more separators (13).

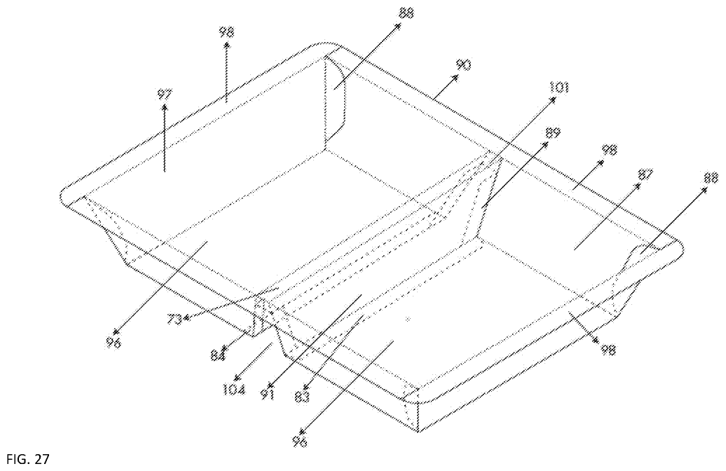

Other trays that are manufactured in accordance with the apparatus and method of the present invention, refer to FIGS. 27 to 32, in these trays identified with the number (90) there does exist a separator that has a different structure from the previous one; the tray (90) comprises: a bottom (96) and side walls (87) as well as side walls (97) which may be totally vertical or inclined; tabs (98) on the upper edge of both the walls (87) and the walls (97), formed by a fold towards the outside; flaps (88) projecting towards the outside of the walls (97), these flaps are attached on the outside to the inside of the walls (87); a separator (82), which is attached to the bottom of the tray (90) on the outside of the tray by the flaps (83) and (84) of the separator (82), additionally the separator (82) is attached to the tray (90) by 2 flaps (89) contained in each of the 2 walls (87) of the tray (90), which are attached to the inside of the wall (91) of the separator (82), forming a space (104), at the top of this space begins a surface (101) that ends where the tabs (98) begin, this space (104) can vary in height depending on the height of the separator (82); the separator has 2 inclined walls (91), which are continued downwards on the mentioned tabs (83) and (84), and upwards they are continued to form a flat wall (73), the separator (82); divides in 2 spaces or compartments a tray (90), resulting among other aspects to avoid that products of different nature are mixed, the spaces in which the tray (90) is divided can be of equal or different magnitude, that is to say the separator (82) is in different positions along the tray (90), also the tray has 2 or more separators (82). The tray described above is structured as a unit that maintains its shape with or without a plastic film (49) adhered to the entire interior surface of the tray, the separator (82) and the tabs (63); the flat wall (73) of the separator (82) has the function that when the lid (75) seals over the tray (90) each independent packaging area, additionally the walls (91) of the separator (82) have different heights according to the requirements of their application.

Trays (67) and (47) and (90) are optionally coated on the inside, as described above, with a plastic film (49) that has the function of making it totally waterproof and without leaving gaps to prevent any type of leakage; a heat sealant varnish is applied to 100% of the surface of the tray or only to register, so that the plastic film adheres totally or partially to the tray.

A wide variety of plastic films are used, including food grade, anti-fog, high barrier, microwave, and heat-sealing varnishes, among others.

The adhesion of the plastic film to the various materials, mainly cardboard and paperboard, is regulated so that it has sufficient strength for its proper functioning, but also to easily remove the plastic film from the various materials, mainly cardboard and paperboard, once it has been used, so that the materials can be recycled separately.

The above description of the separators are only examples since within the scope of the present invention the separators have different shapes and structures, the trays have one or more separators and therefore the trays more than 2 compartments to store different products mainly food; the separators when the tray has a separator are in the middle part of the tray, they can also be in positions that are not the middle part of the tray, with which the volume of packing and transport of the different products mainly food, in each compartment is not the same; when there is more than one separator in the tray, the separators are equidistant, they also have positions in the tray that are not equidistant, which means that the volume of packaging and transport of different products, mainly food, in each compartment is not the same; the separators have different heights, which means that they vary depending on the need of the application for which they are intended. The separator and the tray are designed in such a way that they are stacked on top of each other for a more efficient way of transporting. In addition to the opening at the bottom of the separator, a cut is left in the walls of the separator (the width of the separator and the height may be equal to or less than that of the separator).

The combination of film with cardboard of the present invention reduces to a high degree the use of plastic from which other trays are manufactured, without losing the strength of a structure which supports the contained product.

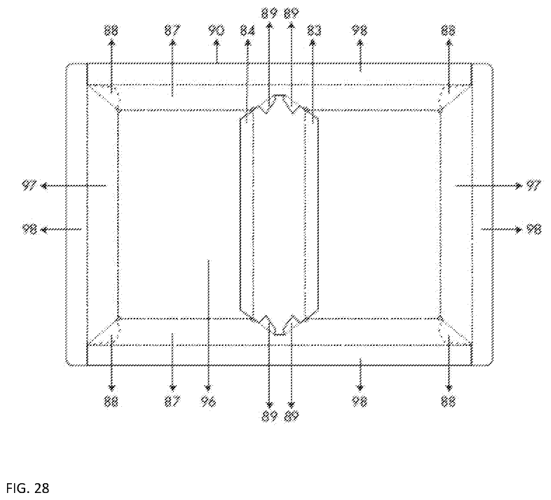

A lid that is used to close the trays (67), (47) and (90), is shown in FIGS. 33 and 34, this lid that is optionally plastic, identified with the number (75) is obtained by the processes of thermoforming, extrusion, or injection, the lid (75) has 2 sides (79) and 2 sides (105); 2 or more pins (78) protrude from each of the 2 sides (79) and are integrated into the same lid as illustrated in FIG. 28, the pins are of the male-female type although they can be used in a different way, the male part of the pin is the one (78) formed by a protrusion from the surface of the lid and the female part is a passage (107); These pins are closed by folding 180 degrees around the tabs (63) and (98), in such a way that the pin (78) enters the passage (107) under pressure so that the lid (75) is firmly retained in the trays, as shown in FIGS. 33 and 34, the lid has an inner frame (108) which represents the lid to the tray, the rest is the surface that goes over the tabs; the tabs (63) and (98) around the trays (67), (47) and (90) make it possible to have several types of closures in the trays, either airtight, modified atmosphere or injected, extruded or thermoformed parts that close under pressure, the lids are also made of cardboard and sealed paper.

In all the above cases the lid is an option, i.e. the trays described above do not necessarily have a lid as described.

Another type of lid that the trays of the present invention have is the so called “Top Seal”, or upper seal.

The trays with or without a separator, in the upper perimeter have tabs (63) sufficiently wide, in this tab (63) and (98), heat-sealing varnishes or polymers are applied, which react to heat, the tab is subjected to a uniform heating, causing a reaction of the heat-sealing varnishes or polymers; the flange (63) and (98) under these conditions are brought into contact with a plastic film, which may contain heat-sealing varnishes, with which reactions take place between the heat-sealing varnishes or polymers and the film, obtaining a chemical bond between them, forming a hermetic seal, the film itself being the lid of the tray.

This method of sealing is known as Top Seal and using this sealing process the atmosphere inside the tray can be modified with so-called modified atmospheres.

Modified atmosphere packaging (MAP) involves the removal of air from inside the package and its replacement by a gas or gas mixture, usually CO2, O2 and N2, in gas diffusion barrier materials. This modification in the gaseous environment decreases the degree of respiration, reduces microbial growth and delays enzymatic deterioration with the purpose of extending the useful life of the product and that fats and liquids do not leave the package.

In the case that the trays (67), (47) and (90) are coated with polyethylene, different types of film are used depending on the characteristics of the product to be packaged such as: all types of food including liquids, besides being able to be refrigerated, and introduced into a microwave oven, it is also possible to be used to contain different materials from other types of industries with abrasive materials, metals, etc.

What is claimed is:

1. Equipment for the manufacture of trays with different structures, characterized by the following elements: a frame in which seven modules or stations are assembled, which are: a first station that includes a stacker of preforms of separators that form part of the trays; a device that sucks the preforms from the trays from the stacker; a conveyor belt in which the device places the preforms to advance to the next station; the second station comprises a double-acting pneumatic press, which contains: a die or female mold with the outer shape of a formed separator; a die or male mold with the inner shape of a formed separator, these elements cooperate to shape the separator; metal guides and at an interval from the conveyor belt so that a formed separator maintains its position and does not lose its shape when transported by the conveyor belt (7) to the third station; the third station comprises an adhesive nozzle, which consists of a hollow inverted “U” shaped container which stores the adhesive; adhesive applicators are placed at the ends of the branches of the hollow inverted “U”, apply the adhesive hot or at room temperature at points on the flaps of formed separators; a conveyor belt after the adhesive application transports the formed separator to the next station; the fourth station comprises a tray preform stacker; a device that sucks up the tray preforms and positions them so that the formed separator on the conveyor belt passes through the opening in the tray preforms until the adhesive flaps make contact with the outside wall around the tray preform opening, forming a formed tray-separator assembly; a conveyor belt carries the assembly or the set to the next station; the fifth station comprises an adhesive nozzle which consists of a U-shaped container with partially hollow, open and inverted branches where adhesive is stored; adhesive applicators which are at the ends of the “U” branches, apply hot-melt or room temperature adhesive to the walls of trays, to regions near flaps or to flaps in the walls of preformed trays; a band, which after application of the adhesive carries the assembly or the assembly to the next station; the sixth station comprises a drive mechanism; a vertical bar having an alternate motion, attached at one end to the drive mechanism; a mechanism attached to the other end of the vertical bar formed by a horizontal bar with a vertical impeller at each end, which perform the pre-bending by pushing up the preform flaps of the trays; a support-counter mechanism such as adjustable precision machined guides, holds the assembly, or the set, at critical points to prevent the assembly or set from bending in undesirable locations; these guides are adjustable over the flat parts of the assembly or set assembly; a band carries the pre-folded assembly or set to the next station; the seventh station comprises a double acting pneumatic press with a counter-mold which is mobile and has the shape of the inner surface of the trays; a perimeter saw in a part near the top of the counter-mold, to cut a plastic film; a plastic film unwinder with controlled feed; a heating system for plastic film, to heat air from the pneumatic system of the apparatus, and introduce it into conduction channels of the counter-mold to direct the air to selected points of the trays and achieve elongation of the plastic film; a mold, fixed, which has the shape of the external surface of the trays; the mold and counter-mold cooperate to form the trays; a vacuum bed provided in the mold has air outlets that attract the plastic film to the bottom of the trays; ducts that are part of the vacuum system; the flaps of the trays remain in position and adhere to the side walls of the formed trays, also the other flaps of the tray walls remain in position and adhere to the walls of the separator when the counter-mold and the mold are closed; an ejection mechanism ejects the formed trays when the counter-mold is opened; a mechanism sucks the trays in and moves them so that by gravity they drop the trays into an accumulator of finished trays.

2. An apparatus for the manufacture of trays with different structures according to claim 1, characterized by the fact that the adhesive jet comprises: a vertical bar having reciprocating and lateral movements; the inverted ‘U’ shaped container is attached to one end of the bar and where the adhesive applicators are pressurized or pneumatic and the adhesive is applied hot or at room temperature to points on the flaps of the formed separator or on the flaps of the formed separator, the ‘U’ shaped container has adapters for applying adhesive to the flaps.

3. An apparatus for the manufacture of trays with different structures, in accordance with claim 1, characterized by the fact that the device which sucks the preforms of trays comprises a vacuum system, which has connected 2 or more suction cups which suck the preforms of trays from the stacker, which are extended and previously die cut.

4. An apparatus for the manufacture of trays with different structures according to claim 1, characterized by the fact that the adhesive injector comprises a vertical bar which has an alternating movement and lateral movements; the inverted “U” shaped container is attached to one end of the bar and where the adhesive applicators are pressurized or pneumatic.

5. An apparatus for the manufacture of trays with different structures according to claim 1, characterized by the fact that the film heating system comprises two sections: the pre-heating section and the forming section; the pre-heating section comprises a fan which blows air at a very low speed through a heating medium such as a set of spiral elements arranged in an orthogonal grid across the width of the film, so as to permit molding in a shorter time; the forming section comprises: a low speed hot air injection system comprising a chamber containing a spiral resistor or other heating medium to heat air entering through the duct from the pneumatic system of the apparatus, the hot air exiting through the ducts and entering the counter-mold.

6. Apparatus for the manufacture of trays with different structures, in accordance with claim 1, characterized by the fact that the mechanism that sucks the trays comprises: suction cups connected to a vacuum system that suck the trays and the mechanism with suction cups moves so that when the vacuum is suspended, by gravity they drop the trays into an accumulator of finished trays.

7. Apparatus for the manufacture of trays with different structures, in accordance with claim 1, characterized by a recess in a small portion in any part of the perimeter of the movable counter-mold to reduce the pressure between the film and the tray material in the area of the tabs, to reduce adherence and to generate a release flap of the film when it has been used and recycled.

8. An apparatus for the manufacture of trays with different structures, in accordance with claim 1, characterized by the fact that the perimeter saw comprises a cutting blade; a support for the cutting blade, and an adjusting pin for the cutting blade, the saw being mounted on spring-loaded guides located in the upper part of the counter-mold, which keep it raised; a lever mechanism causes the saw to lower and cut the plastic film when the counter-mold is lowered; the lever mechanism contracts and returns the saw to its raised position, ready for the next operation.

9. Apparatus for the manufacture of trays with different structures, in accordance with claim 1, characterized by the fact that formed trays are supplied at the fourth station, so that the fifth and sixth stations remain non-functional.

10. Apparatus for the manufacture of trays with different structures, according to claim 1, characterized by having more than one seventh station working in parallel to compensate for the lower speed of the seventh station with respect to the other stations.

11. An apparatus for the manufacture of trays with different structures, in accordance with claim 1, characterized by the fact that the apparatus of the present invention is modular, so that during its operation all the stations work, or some of them work, and some stations receive trays or separators already formed.

12. A method to manufacture trays with different structures, characterized by the manufacture of trays with a separator, coated with a plastic film, where in the first station of the apparatus, in a first stage, the apparatus is fed with the preforms already die cut, either the separator or the separator in the stacker or accumulator of the first station and the preforms from the tray or from the tray in the stacker or accumulator of the fourth station; in a second stage, in the first station a suction cup takes the preform from the separator or the preform and places it on a conveyor belt, which moves one of these preforms to a second station. In the second station, in a first stage, the preform from the separator or the preform from the separator is transported by the belt until it is placed between the die or female mold which has the outer shape of the separator and the die or male mold which has the inner shape of the separator of the double acting pneumatic press, these dies are interchangeable for others, one being the female die which has the outer shape of the separator and the male die which has the inner shape of the separator; in a second stage the press goes into operation and closes the dies or female mold and male mold to shape the separator, resulting in the formed separator or formed separator; in a third stage, the formed separator is positioned between metal guides placed on the conveyor belt, so that the formed separator maintains its position and does not lose its shape when transported on the belt to the third station; in the third station, in a first stage the adhesive injector, once the flaps are in position approaches the flaps and by a slight pressure with the applicators injects adhesive in hot or at room temperature, at selected locations on the flaps, whereby the formed separator is ready to adhere to the outer surface of the preform in the trays, on the perimeter of the opening of the preform in the tray or on the perimeter of the opening of the preform; when the formed separator, has the adhesive placed on the flaps, by the conveyor belt it advances to the fourth station. In the fourth station, in a first stage, a vacuum system with 2 or more suction cups connected, sucks a preform tray extended, previously die cut, from a stack of preforms and places it in a position where the formed separator is on the conveyor belt, passes through the opening respectively of the preform trays, until the flaps with adhesive make contact with the outer wall around the opening of the preform of the trays, whereby the separator is firmly attached to the outer surface of the preformed tray, forming an assembly, or until the adhesive flaps contact the outer wall around the opening of the preform of the trays, whereby the separator is firmly attached to the outer surface of the preformed tray, forming a set; in a second stage, the conveyor belt leads the assembly or the set to the fifth station; in the fifth station, in a first stage the bar makes an alternate movement, as well as lateral movements, so that the adhesive injector, makes a slight pressure with the adhesive applicators on the walls, of the preform of the tray in an area near the flaps, or on the walls in an area near the flaps, as well as on the flaps on the walls, the above so that the hot-melt or at room-temperature adhesive is applied at selected points on the walls and flaps mentioned above; in a second stage after the adhesive has been applied, the bar raises the adhesive nozzle; the formed separator firmly adhered to the preform, which forms the assembly, or the set is transported by the belt to the sixth station for subsequent forming. In the sixth station in a first stage, is placed to avoid that the assembly or the set is bent in undesired places; in a second stage the vertical bar which makes an alternating movement, moves upwards when a drive mechanism, which is a pneumatic cylinder, detects the position of the assembly or the set and when in position, the mechanism formed by a horizontal bar which is attached to the bar, and 2 or more vertical drives at the ends of the bar, are activated by pushing the flaps of the assembly or the flaps to pre-fold them, to control the folding in the next station, in a third stage the support counter-mechanism is removed, and the bar performs a downward movement, whereby the assembly with the pre-folded flaps or the assembly with the pre-folded flaps, is transported by the belt to the next station; in the seventh station, at the end of the belt; in a first stage the plastic film is preheated by a fan blowing air at a very low speed through a heating medium, thus raising the temperature of the plastic film to make it malleable, the film is supplied by a unwinder at a controlled feed rate; in the second stage the assembly or the set is placed at the entrance to the mold, the counter-mold and the plastic film are placed on top of the assembly or the set; in the third stage the final heating of the molding film is carried out by means of a low speed hot air injection system, to heat air coming from the pneumatic system of the machine, entering through the duct, the hot air exits through the ducts and enters into conduction channels arranged in the counter-mold, to direct the air to selected points of the trays, to achieve elongation and adherence of the plastic film; in the fourth stage, the upper piston makes a downward movement so that the assembly or the set is pressed by the counter-mold which is mobile, against the mold which is fixed, making the flaps stay in position and stick to the walls of the tray, or by making the flaps stay in position and stick to the walls and the wall respectively, the latter being the outer wall of the separator, all these flaps varying in shape and dimension; the above in synchronization with the suction and cutting of the film in addition to pressing the plastic film against the tray or in the tray to make the seal on the tabs of the trays so as not to allow leaks in the suction of the rest of the film, during this stage the film is suctioned by the vacuum bed, where the ducts are part of the vacuum system, to the bottom of the tray or to the bottom of the tray, because the vacuum bed sucks air through the holes previously arranged at different points in the bottom of the tray, which can vary in size and position, even if the material is sufficiently porous no holes are made in the tray cardboard; the excess film is trimmed synchronously around the tray by a perimeter saw, after the operations performed previously the upper piston makes an upward movement which releases a space over the mold containing the formed tray; in the fifth stage an ejection mechanism enters the mold through the ducts and pushes the tray upwards towards the outside of the mold, additionally a mechanism with suction cups connected to a vacuum system sucks the tray, and the mechanism with suction cups moves so that when the vacuum is interrupted, by gravity they drop the trays into an accumulator of finished trays.

13. The method of manufacturing trays with different structures, according to claim 12, characterized by the manufacture of trays with a separator, without a plastic film coating, where the stages for the first to sixth stations are the same as those claimed in claim 12; in the seventh station, in a first stage, the assembly or the set is placed at the entrance of the mold, the counter-mold is placed above the assembly or the set; in the second stage, the upper piston makes a downward movement which causes the assembly or the set to be pressed by the counter-mold which is movable, towards the mold which is fixed, causing the flaps to remain in position and stick to the walls of the tray, or by having the flaps stay in position and stick to the walls and the wall, respectively, the latter being the outer wall of the separator all these flaps vary in shape and dimension; after the above operations the upper piston makes an upward movement which frees up a space on the mold containing the formed tray; in the third stage an ejection mechanism enters the mold through the ducts and pushes up the tray to the outside of the mold, additionally a mechanism with suction cups connected to a vacuum system sucks the tray, and the mechanism with suction cups moves so that when the vacuum is interrupted, by gravity they drop the trays into an accumulator of finished trays.

14. The method of manufacturing trays with different structures, in accordance with claim 13, characterized by the manufacture of trays without a separator and with a plastic film coating, where the method starts from the fourth station; at the fourth station in a first stage, a vacuum system which has 2 or more suction cups connected, sucks an extended preform tray, previously die cut and printed from a stack of preforms and places it in a position where the conveyor belt carries the preform tray to the fifth station; in the fifth station, in a first stage, the bar makes an alternate movement, as well as lateral movements, so that the adhesive nozzle, makes a slight pressure with the adhesive applicators of the inverted “U” arms on the walls in an area near the flaps, of the preform of the trays, the above so that the adhesive in hot or at room temperature is applied in selected points of the walls for the optimal gluing; in a second stage, once the adhesive has been applied to the walls of the preform of the trays, this preform is transported by the belt to the sixth station for its subsequent forming; in the sixth station, a support mechanism is first placed on the tray preform without a separator, such as precision-machined aluminum guides to prevent the preform from bending at undesirable places; in a second stage, the bar is moved upwards by a drive mechanism, which detects the position of the tray preform without separator; when in position, the mechanism formed by a horizontal bar and its 2 or more vertical drives at the ends of the bar, actuate, push the flaps of the preform tray to pre-fold them to control the folding at the next station; in a third stage, the support mechanism is removed and the bar makes a downward movement, so that the preform without separator with the pre-folded flaps is transported by the belt to the next station; at the seventh station in a first stage the plastic film is preheated by a fan blowing air at a very low speed, thus raising the temperature of the plastic film to make it malleable, the film is supplied by a unwinder at a controlled feed rate; in the second stage the tray preform without separator is placed at the mold inlet, the counter-mold and the plastic film are placed on top of the tray preform without separator; in the third stage the final heating of the molding film is carried out by means of a low speed hot air injection system, the hot air exits through the ducts and enters into conduction channels arranged in the counter-mold, to direct the air to selected points of the trays, to achieve elongation and adhesion of the plastic film; in the fourth stage the upper piston makes a downward movement so that the preform of tray without separator is pressed towards the mold by the counter-mold making the flaps stay in position and stick to the walls of the tray, these flaps vary in shape and dimension; in synchronization with the suction and cutting of the film in addition to pressing the plastic material against the tray at the edges to make the seal on the tabs of the tray so as not to allow leakage in the suction of the rest of the film, thus shaping the tray while adhering the film to the tray because the film is thermo-adhesive, during this stage the film is suctioned by the vacuum bed, to the bottom of the tray because the vacuum bed sucks air through the holes previously arranged at different points in the tray, which can vary in size and position, even if the material is sufficiently porous no holes are made in the film board around the tray by a notched system, which cuts the film either hot or cold, after the operations performed previously the upper piston makes an upward movement which releases a space on the mold containing the formed tray; in the fifth stage a mechanism enters through the ducts pushing upwards the tray towards the outside of the mold, where a transport device of the formed trays, provided with a suction device makes contact with the bottom of the tray and sucks it in, the mechanism with suction cups moves so that when the vacuum is interrupted, by gravity they drop the trays into an accumulator of finished trays.

15. The method for manufacturing trays with different structures, according to claim 12, characterized by the manufacture of trays without a separator and without a plastic film coating, where the stages for the first to sixth stations are the same as those claimed in claim 12; in the seventh station, in a first stage, the preform of tray without separator is placed at the entrance of the mold, the counter mold is placed on top of the preform of tray without separator; in the second stage, the upper piston makes a downward movement, so that the preform without separator is pressed by the counter-mold that is mobile, towards the mold that is fixed, making the flaps stay in position and stick to the walls of the tray. After the operations made previously, the upper piston makes an upward movement, so that a space is released on the mold containing the formed tray; in the third stage an ejection mechanism enters through the ducts and pushes up the tray towards the outside of the mold, additionally a mechanism provided with suction cups connected to a vacuum system makes contact with the bottom of the tray and sucks it in, the mechanism with suction cups moves so that when the vacuum is interrupted, by gravity they drop the trays into an accumulator of finished trays.

16. (canceled)

17. (canceled)

18. (canceled)

19. Trays with different structures, characterized by the fact that the trays comprise a bottom and side walls, as well as side walls which may be totally vertical or inclined; tabs on the upper edge of both the walls and the walls, formed by a bend towards the outside; the trays are made of various materials mainly of cardboard and paperboard; flaps projecting outwards from the walls, these flaps are attached on the outside to the inside of the walls resulting in the trays being structured as a unit which retains its shape with or without the plastic film attached to the inside of the unit, these flaps vary in shape and dimension.

20. Trays with different structures, according to claim 19, characterized by the fact that the trays comprise a bottom, side walls and sidewalls, which may be totally vertical or inclined; tabs on the upper edge of both the walls and the walls are formed by a fold towards the outside, all made of the same material preferably cardboard and paperboard flaps which project outwards from the walls, these flaps vary in shape and dimension and when the tray is formed they stick on the outside to the inside of the walls, resulting in the trays being structured as a unit which retains its shape with or without a plastic film adhering to the entire inner surface of the tray and to that of the flaps; a separator formed, which is attached to the bottom of the tray, on the outside of the tray, the separator is formed by 2 sloping walls, which are continued in some tabs, which are the ones that are attached to the bottom of the tray, on the outside, the side walls are continued towards the front with some tabs and on the back with some tabs, these are the ones that stick to the walls of the tray, on the outside; the side walls of the separator when they are bent form a vertex, the separator, divides in 2 spaces or compartments a tray, resulting among other aspects to avoid that products of different nature are mixed, the spaces in which the tray is divided can be of equal or different magnitude, that is to say the separator is in different positions along the tray, also the tray has 2 or more separators.

21. Trays with different structures, according to claim 19, characterized because the trays comprise: a bottom and side walls as well as side walls which may be totally vertical or inclined; tabs on the upper edge of both the walls and the walls, formed by a fold towards the outside; flaps projecting towards the outside of the walls, these flaps are attached on the outside to the inside of the walls; a separator, which is attached to the bottom of the tray on the outside of the tray by the flaps of the separator, additionally the separator is attached to the tray by 2 flaps contained in each of the 2 walls of the tray, which are attached to the inside of the wall of the separator, forming a space, at the top of this space begins a surface that ends where the tabs begin, all these flaps vary in shape and dimension; this space can vary in height depending on the height of the separator; the separator has 2 inclined walls, which are continued downwards in the mentioned tabs, and upwards they are continued to form a flat wall, the separator; divides in 2 spaces or compartments a tray, resulting among other aspects to avoid that products of different nature are mixed, the spaces in which the tray is divided can be of equal or different magnitude, that is to say the separator is in different positions along the tray, also the tray has 2 or more separators; the tray is structured as a unit that maintains its shape with or without a plastic film adhered to the entire interior surface of the tray, the separator and the tabs; the flat wall of the separator has the function that when the lid seals over the tray each independent packaging area, additionally the walls of the separator have different heights according to the requirements of their application.

22. Trays with different structures according to claim 19, characterized because optionally they are coated in its interior with a plastic film that has the function of making it totally impermeable and without leaving holes to avoid any type of runoff; a thermo-sealing varnish applied in 100% of the surface of the tray or only to register, so that the plastic film adheres totally or partially to the tray; plastic films are such as food grade, anti-fog, high barrier, microwave, which may contain heat-sealing varnishes, the adhesion of the plastic film to the various materials mainly cardboard and cardboard of the trays, is regulated so that it has sufficient strength for its proper functioning, but also to easily remove the plastic film from the various materials once it has been used, so that the materials can be recycled separately.

23. Trays with different structures according to claim 19, characterized because they optionally contain a lid that is used to close the trays, this lid that optionally is plastic, is obtained by the processes of thermoforming, extrusion, or injection, the lid has 2 sides and 2 sides; 2 or more clips protrude from each of the 2 sides and are integrated into the same lid, the clips preferably being of the male-female type, a male part of the clip being a protrusion from the surface of the lid and a female part being a passage; these fasteners are closed by folding 180 degrees around the flanges by snapping the protrusion into the passage; the flanges around the trays make it possible to have various types of closure on the trays, either airtight, modified atmosphere or injected, extruded or thermoformed parts which close under pressure; the lids are also made of cardboard and sealed paper.

24. Trays with different structures according to claim 19, characterized by the fact that they optionally contain a lid which is used to close the trays with a top seal, trays with or without a separator, in the upper perimeter have sufficiently wide flanges, these flanges are impregnated with heat-sealing varnishes or polymers, which react to heat, and by uniform heating a reaction of the heat-sealing varnishes or polymers is caused; the tabs in these conditions are put in contact with a plastic film, which may contain heat-sealing varnishes, and so reactions take place between the heat-sealing varnishes or polymers and the film, obtaining a chemical bond between them, forming a hermetic seal, the film itself is the lid of the tray, with this lid the container may contain modified atmospheres.
